(19) United States
(12) Patent Application Publication
(10) Pub. No.: US 2014/0156652 A1
(43) Pub. Date: Jun. 5, 2014

(54) DATA MATCHING

(71) Applicant: Modupeola Shakirat Abiola, Greater London (GB)

(72) Inventor: Modupeola Shakirat Abiola, Greater London (GB)

(73) Assignee: BRIGHT SIX LIMITED, Greater London (GB)

(21) Appl. No.: 14/115,554

(22) PCT Filed: May 3, 2012
(86) PCT No.: PCT/GB2012/050969

§ 371 Date: Feb. 11, 2014

(30) Foreign Application Priority Data
May 3, 2011 (GB) 1107217.0
Mar. 13, 2012 (GB) 1204410.3

(51) Int. Cl. G06F 17/30

(52) U.S. Cl. CPC G06F 17/3053
USPC 707/723

(57) ABSTRACT

A computer-implemented method of matching data sets against a desired data set characteristic. First and second data sets comprising first and second sets of attributes respectively are received. A predetermined data set characterisation scheme is selected from a plurality of such schemes. The selected scheme corresponds to a set of desired attributes indicative of the strength of a match against the desired characteristic. The desired attributes corresponding to the selected scheme are identified. Weighting indicators indicating a relative weighting of each of the desired attributes is retrieved from a database. The desired attributes are matched with attributes in the first and second sets. The first and second sets are ranked in relation to the scheme on the basis of the matching and the retrieved set of weighting indicators. A report identifying the first and second sets and the relative rank of the sets in relation to the scheme is generated.

### TECHNICAL FIELD

The present invention relates to data matching and in particular, but not exclusively, to a computer-implemented method of matching candidate data sets against one or more desired data set characteristics in a data communication system.

### BACKGROUND

With ever-increasing amounts of data, it can be difficult to identify data that matches certain requirements. In other words, it can be difficult to distinguish between data that is relevant and data that is not relevant in a given context. One approach for distinguishing in this way is to filter large amounts of data to include data that is known to be relevant and/or to exclude data that is known not to be relevant in the given context, for example by specifying that the data must or must not include certain elements.

One context in which data matching is relevant is in recruitment, where multiple candidates apply for a given opportunity and where a decision needs to be made as to which candidate is most suitable for the opportunity.

One way in which employers try to attract potentially suitable candidates is to advertise available opportunities on job boards, for example on Internet-based job boards. This involves posting a description of the opportunities and listing sought qualifications and qualities. The advert is then displayed so that interested candidates can apply. Although this may result in an increased number of applications for the opportunity and therefore, possibly an increased number of candidates that are suitable for the opportunity, there is no assurance that the applicants for the role do indeed have the listed qualifications and qualities. It is not uncommon to receive several thousand applications for a given opportunity. It can be not only highly time-consuming to review all of the applications to determine whether the associated candidates are suitable for the opportunity, but also be frustrating when some applicants are clearly not suitable for the advertised role.

To address this problem somewhat, systems exist wherein a candidate may upload their Curriculum Vitae (CV) to an online CV database. Employers can then search for certain keywords that are likely to be relevant to the opportunity in the uploaded CVs. For example, an employer might search through the online CV database using the term “accountancy” to search for candidates who might be suitable for a vacancy at an accountancy firm. It is, however, quite possible for the employer to miss a strong candidate for the opportunity, for example if the candidate did not use the searched term “accountancy” in their CV. For example, the candidate may have used the word “accountant”, “financial consultant” or the like throughout instead.

Even if a desired keyword is included in a CV and is searched by the employer, there is still no assurance that the candidate is actually suitable for the available role. For example, the candidate may only have very limited experience in accountancy, such as a week-long work experience in an accountancy firm while they were at school.

It would therefore be desirable to provide improvements in data matching, particularly, but not exclusively, to ameliorate at least some of the above-described problems of improving the matching of candidates against employment or other opportunities.

### SUMMARY

According to an aspect of the invention, there is provided a computer-implemented method of matching a plurality of candidate data sets against one or more desired data set characteristics in a data communication system, the method comprising:

receiving a first candidate data set comprising a first set of candidate data set attributes;

receiving a second candidate data set comprising a second set of candidate data set attributes;

selecting a predetermined candidate data set characterisation scheme from a plurality of predetermined candidate data set characterisation schemes, the selected predetermined candidate data set characterisation scheme corresponding to a set of desired candidate data set attributes indicative of the strength of a match against the one or more desired data set characteristics;

identifying the desired candidate data set attributes corresponding to the selected predetermined candidate data set characterisation scheme;

retrieving, from one or more databases, a set of weighting indicators indicating a relative weighting of each of the desired candidate data set attributes;

matching the desired candidate data set attributes with candidate data set attributes in the first and second candidate data sets;

ranking the first and second candidate data sets in relation to the selected predetermined candidate data set characterisation scheme at least in part on the basis of said matching and said retrieved set of weighting indicators; and

generating one or more reports identifying the first and second candidate data sets and the relative rank of the first and second candidate data sets in relation to the selected candidate data set characterisation scheme.

Thus, instead of merely filtering candidate data sets based on whether or not they comprise desired data set characteristics, more holistic or abstracted data matching is provided by matching candidate data sets having certain candidate data set attributes against one or more desired data set characteristics that are associated with a set of desired candidate data set attributes indicative of the strength of a match against the one or more desired data set characteristics. The weighting indicators and relative weightings may be used to influence the rankings of candidates data sets that have having certain key desired candidate attributes so that better-matching candidate data sets can be more readily reported.

In some embodiments, at least some of the candidate attributes comprise an attribute type identifier and an attribute value identifier associated with the attribute type identifier. In some embodiments, the attribute type identifier comprises a pointer into a table of attribute types. In some embodiments, the attribute value identifier comprises a pointer into a table of attribute values. Such embodiments may provide more efficient storing, retrieving and searching of data sets by enabling the use of identifiers that require less storage space than the corresponding attribute type or attribute value.

In some embodiments, the weighting indicators indicate a relative weighting of any ones of said at least some of the candidate attributes that comprise different attribute type identifiers but corresponding attribute value identifiers associated with the different attribute type identifiers. Such embodiments may enable desired candidate data set characteristics to be defined more precisely to improve the accuracy of data matching. For example, different ranking weightings may be associated with the corresponding attribute value identifiers dependent on the particular attribute value identifier with which they are associated.

In some embodiments, the weighting indicators indicate a relative weighting of any ones of said at least some of the candidate attributes that comprise corresponding attribute type identifiers but different attribute value identifiers associated with the corresponding attribute type identifiers. Such embodiments may enable desired candidate data set characteristics to be defined more precisely to improve the accuracy of data matching. For example, different ranking weightings may be associated with the corresponding attribute identifiers dependent on the particular attribute value with which they are associated.

In some embodiments, the relative weightings of at least some of the desired candidate data sets attributes are dynamic. Such embodiments may improve the accuracy of matches by taking into account factors that may indicate or warrant a change in the relative weightings.

Some embodiments comprise:

receiving weighting data associated with at least some of the desired candidate data set attributes; and

deriving, based at least in part on the received weighting data, the relative weighting of the at least some of the desired candidate data set attributes.

Such embodiments may improve the accuracy of matches by basing the relative weightings at least in part on received, for example from an external source, weighting data. The received weighting data may indicate one or more factors and/or may include one or more parameters, based on which the relative weighting may be derived and/or modified, for example to take into account extrinsic information that may influence the relative weightings.

In some embodiments, the received data comprises information from one or more publicly available attribute ranking databases. Such embodiments use readily available information to improve the accuracy of matches.

In some embodiments, at least some of the relative weightings are based at least in part on one or more weighting adjustment parameters. Such embodiments may improve the accuracy of matches by providing a mechanism to adjust the relative weightings, for example to take into account additional factors that may influence the relative weightings.

Some embodiments comprise:

selecting a further predetermined candidate data set characterisation scheme from the plurality of predetermined candidate data set characterisation schemes, the selected further predetermined candidate data set characterisation scheme corresponding to a set of further desired candidate data set attributes indicative of the strength of a match against the one or more further desired data set characteristics;

identifying the further desired candidate data set attributes corresponding to the selected further predetermined candidate data set characterisation scheme;

retrieving, from one or more databases, a set of weighting indicators indicating a relative weighting of each of the further desired candidate data set attributes;

matching the further desired candidate data set attributes with candidate data set attributes in the first and second candidate data sets;

ranking the first and second candidate data sets in relation to the selected further predetermined candidate data set characterisation scheme at least in part on the basis of said matching and said retrieved set of weighting indicators; and

generating one or more reports identifying the first and second candidate data sets and the relative rank of the first and second candidate data sets in relation to the selected further candidate data set characterisation scheme.

Such embodiments may improve the accuracy of matches by providing another layer of holistic characteristic-based matching. Such embodiments may enable the granularity of matching requirements to be varies, for example to specify further desired candidate data set characteristics to enable a more accurate match.

Some embodiments comprise:

identifying one or more additional candidate data set attributes associated with a given candidate data set, the strength of a match of the one or more additional candidate data set attributes against the one or more desired data set characteristics being known; and

ranking the first and second candidate data sets in relation to the selected predetermined candidate data set characterisation scheme at least in part on the basis of matching the first and second sets against the identified one or more additional candidate data set attributes.

Such embodiments may improve the accuracy of matches by taking into account candidate data set attributes having a known matching strength against the one or more desired data set characteristics. The matching strength may be known to be low (for example if the one or more additional candidate data set attributes is known to indicate a weak match), in which case matching accuracy may be improved by ranking candidate data sets having corresponding data set attributes relatively low. The matching strength may, instead, be known to be high (for example if the one or more additional candidate data set attributes is known to indicate a strong match), in which case matching accuracy may be improved by ranking candidate data sets having corresponding data set attributes relatively low.

Some embodiments comprise:

receiving the first and second candidate data sets via one or more data communication networks.

Some embodiments comprise:

transmitting data associated with the one or more generated reports via one or more data communication networks.

According to a further aspect of the invention, there is provided a data matching platform for matching a plurality of candidate data sets against one or more desired data set characteristics in a data communication system, the data matching platform being arranged to:

receive a first candidate data set comprising a first set of candidate data set attributes;

receive a second candidate data set comprising a second set of candidate data set attributes;

select a predetermined candidate data set characterisation scheme from a plurality of predetermined candidate data set characterisation schemes, the selected predetermined candidate data set characterisation scheme corresponding to a set of desired candidate data set attributes indicative of the strength of a match against the one or more desired data set characteristics;

identify the desired candidate data set attributes corresponding to the selected predetermined candidate data set characterisation scheme;

retrieve, from one or more databases, a set of weighting indicators indicating a relative weighting of each of the desired candidate data set attributes;

match the desired candidate data set attributes with candidate data set attributes in the first and second candidate data sets;

rank the first and second candidate data sets in relation to the selected predetermined candidate data set characterisation scheme at least in part on the basis of said matching and said retrieved set of weighting indicators; and

generate one or more reports identifying the first and second candidate data sets and the relative rank of the first and second candidate data sets in relation to the selected candidate data set characterisation scheme.

According to a further aspect of the invention, there is provided a computer program product comprising a non-transitory computer-readable storage medium having computer readable instructions stored thereon, the computer readable instructions being executable by a computerized device to cause the computerized device to perform a computer-implemented method of matching a plurality of candidate data sets against one or more desired data set characteristics in a data communication system, the method comprising:

receiving a first candidate data set comprising a first set of candidate data set attributes;

receiving a second candidate data set comprising a second set of candidate data set attributes;

selecting a predetermined candidate data set characterisation scheme from a plurality of predetermined candidate data set characterisation schemes, the selected predetermined candidate data set characterisation scheme corresponding to a set of desired candidate data set attributes indicative of the strength of a match against the one or more desired data set characteristics;

identifying the desired candidate data set attributes corresponding to the selected predetermined candidate data set characterisation scheme;

retrieving, from one or more databases, a set of weighting indicators indicating a relative weighting of each of the desired candidate data set attributes;

matching the desired candidate data set attributes with candidate data set attributes in the first and second candidate data sets;

ranking the first and second candidate data sets in relation to the selected predetermined candidate data set characterisation scheme at least in part on the basis of said matching and said retrieved set of weighting indicators; and

generating one or more reports identifying the first and second candidate data sets and the relative rank of the first and second candidate data sets in relation to the selected candidate data set characterisation scheme.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic representation of a data communication system in accordance with some embodiments.

FIG. 2 is a flow chart showing a computer-implemented method according to some embodiments.

FIG. 3 is a flow chart showing a computer-implemented method according to some embodiments.

FIG. 4 is a flow chart showing a computer-implemented method according to some embodiments.

FIG. 5 is a representation of a side by side candidate profile comparison in accordance with some embodiments.

FIG. 6 is a representation of a dynamic availability dashboard in accordance with some embodiments.

FIG. 7 is a representation of a candidate ranking record in accordance with some embodiments.

FIG. 8 is a representation of a generated report in accordance with some embodiments.

FIG. 9 is a representation of a list of connections in accordance with some embodiments.

FIG. 10 is a representation of an interview arrangement page in accordance with some embodiments.

FIG. 11 is a representation of payment and transaction page in accordance with some embodiments.

FIG. 12 is a representation of a login page in accordance with some embodiments.

FIG. 13 is a representation of a login page in accordance with some embodiments.

FIG. 14 is a representation of a dashboard page in accordance with some embodiments.

FIG. 15 is a representation of a profile building prompt page in accordance with some embodiments.

FIG. 16 is a representation of an internship preference page in accordance with some embodiments.

FIG. 17 is a representation of an availability profile wizard page in accordance with some embodiments.

FIG. 18 is a representation of an academic information profile wizard page in accordance with some embodiments.

FIG. 19 is a representation of a school profile wizard page in accordance with some embodiments.

FIG. 20 is a representation of a languages profile wizard page in accordance with some embodiments.

FIG. 21 is a representation of a skills profile wizard page in accordance with some embodiments.

FIG. 22 is a representation of a work experience profile wizard page in accordance with some embodiments.

### DETAILED DESCRIPTION

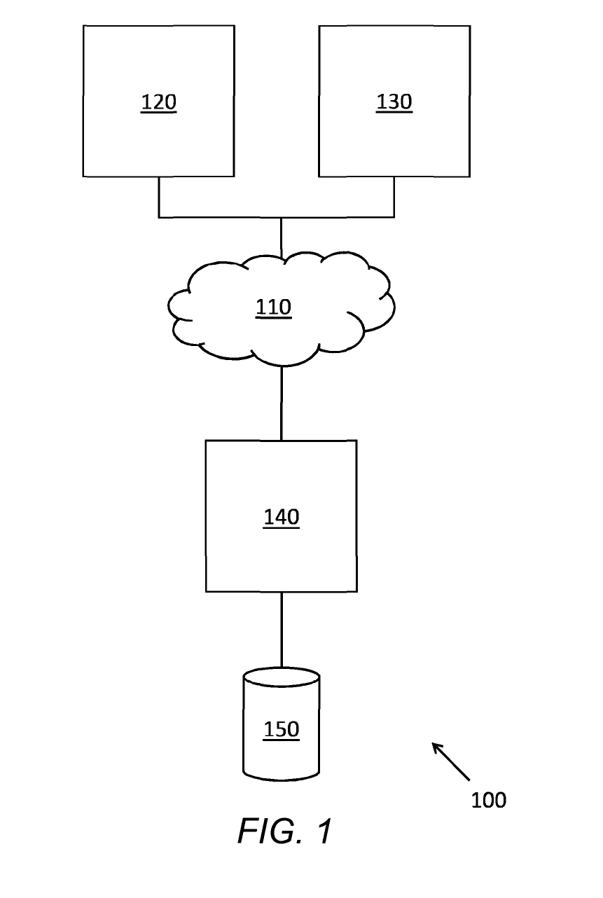

FIG. 1 is a schematic representation of a data communication system 100 in accordance with some embodiments.

The data communication system 100 is arranged to perform a computer-implemented method of matching candidate data sets against one or more desired candidate data set characteristics.

Although various embodiments described herein relate to the matching of candidates against employment or other opportunities, it will be appreciated that other embodiments are envisaged and described herein.

In some embodiments, the data communication system 100 comprises a data communication network 100, for example a wireless or wired data communication network 100. The data communication network 100 may comprise switches, routers load balancers and the like.

The data communication system 100 also comprises an opportunity provider 120 (for example an employer or recruiter) and a plurality of candidates 130 for an opportunity (for example an internship or job) provided by the opportunity provider 120. The opportunity provider 120 and/or the plurality of candidates 130 may each be associated with one or more data communication devices, such as, but not limited to mobile telephones, tablet computing devices, laptops, smart TVs, PDAs desktop computing devices or the like. The data communication system 100 may comprises a plurality of opportunity providers 120.

The candidates 130 may be potential employees, consultants, interns, secondees or the like and the opportunity providers 120 may be employers, recruiters or the like. Embodiments are also envisaged in which the candidates 130 are employers, recruiters or the like and the opportunity providers 120 are potential employees, consultants, interns, secondees or the like. For example, a consultant may provide a consulting opportunity to various companies, the companies being given the opportunity to use the services of the consultant and being candidates 130 for such services. Alternatively or additionally, a consultant may be a candidate 130 for a consultancy opportunity at a company that provides, for example, professional services, the consultant therefore being the candidate 130 and the company being the opportunity provider 120. Other types of candidate-opportunity provider relationship are envisaged.

The computer-implemented method may be performed on a data matching platform 140, or multiple such platforms. The data matching platform 140 may be used, for example, for matching, assessment, application, training and screening for use, inter alia, in job recruitment, job searching and/or for internships. As explained above, other data-matching uses are envisaged and are described herein.

A data matching platform 140 may comprise one or more computing devices, such as one or more physical and/or virtual servers. At least some of the computing devices may be physically co-located or may be located remote from each other. The data matching platform 140 may comprise a Virtual Private Server (VPS) system comprising a plurality of virtual servers. The data matching platform 140 may comprise a physical server system comprising a plurality of physical servers. The data matching platform 140 may comprise a combination of one or more physical servers and one or more virtual severs, for example with the virtual severs serving as fallback servers in the event of a failure of the physical server(s).

The data communication system 100 also comprises one or more databases 150, implemented for example in one or more database servers. The one or more databases 150 may be physically local to, or remote from, the data matching platform 140. The one or more databases 150 may form part of the data matching platform 140.

The data matching platform 140 receives a first candidate data set comprising a first set of candidate data set attributes (also referred to herein as ‘candidate attributes’) that may be associated with a first candidate 130. The data matching platform 140 also receives a second candidate data set comprising a second set of candidate data set attributes, which may be associated with a second candidate 130. The data matching platform 140 may receive the first and second candidate data sets via the data communication network 100 for example from the one or more data communication devices associated with the first and second candidates 130.

Some embodiments provide a standardised format for and capture of candidate data or information. The data matching platform 140 may create standardised profiles for candidates 130, collecting attribute data relevant to their contact information, professional work experience, job preferences, academic qualifications, language and IT skills, awards, reference information, and diversity information.

The data matching platform 140 may collect standardised and relevant information from each user group, for example opportunity information from opportunity providers 120 and professional and academic information from candidates 130. This standardised information enables the data matching platform 140 to profile each group and collect and store a set of relevant facts or ‘attributes’ that can be used to assess the suitability of either group to the other. The data matching platform 140 may collect this information from each user and a list of relevant facts or attributes is built up. The list can be stored in the one or more databases 150 and searched against.

In some embodiments, for each candidate 130 who has a profile completeness of, for example, at least 40% (or who has otherwise provided with a suitable level of data sufficiency), the data matching platform 140 analyses the attribute data associated with the candidate 130 and creates instant search functionality for employers.

In some embodiments, each candidate 130 is given a unique user ID upon subscribing to the matching service provided by the data matching platform 140 and needs to complete a profile after joining if they wish to look for and/or be considered for opportunities. Each candidate profile contains a large amount of data or candidate attributes that can be used to determine whether the candidate 130 meets the basic requirement of the employer or opportunity and how strongly they meet those requirements. For each candidate attribute, the data matching platform 140 creates a new row in a table that is stored in the one or more databases 150. This creates a large table that can be used to group all the users together using their respective user IDs. The table can then be queried to determine all of the known information relating to a given candidate 130.

The data matching platform 140 may comprise or provide an optimised caching mechanism or algorithm for storing the candidate information in the table, where the caching mechanism is optimised for quick and efficient storage of candidate data.

As explained above, a given candidate 130 is associated with a unique user ID. The given candidate 130 is also associated with a plurality of candidate attributes. Candidate attributes may include, but are not limited to, a course of study, a university of study and a particular skill offered by the candidate 130.

At least some of the candidate attributes may comprise an attribute type identifier and an attribute value identifier associated with the attribute type identifier. In some embodiments, at least some, or all, of the candidate attributes comprise one or more attribute type identifiers and one or more attribute value identifiers associated with the one or more attribute type identifiers. In other words, the candidate attribute may comprise two (or more) parts; an attribute-type identifier (for example that the attribute relates to the course of study) and an attribute value identifier (for example, the particular course studied by the candidate 130).

The attribute-type identifier and/or the attribute value identifier need not be the same as the attribute type and/or attribute value itself For example, a code could be used to identify a particular course of study. The code could correspond to an externally used course-identification code or may be an internal code used within the data matching platform 140. The use of such identifiers (for example codes) may be beneficial in terms of standardisation of data as between candidates 130 and opportunity providers 120; this may improve the accuracy of matches and searches. The use of such identifiers (for example short numerical codes that serve as pointers or indexes into a table) may also be beneficial in terms of the amount of time required to store and retrieve candidate data and the amount of storage space required in the one or more databases 150 to store the candidate data.

By way of a non-limiting example, a given candidate 130 has a unique User or Candidate ID ‘13445’. The candidate 130 studied engineering at Newcastle University and also has a particular skill in engineering.

A first user attribute comprises an attribute-type identifier ‘qualification_course’ or a field/attribute-type ID or code of ‘3455’, which has an associated attribute value identifier of ‘567’, which is associated with an Engineering course. The candidate 130 has another associated candidate attribute that identifies that the ‘qualification_university’ or ‘1453’ attribute-type identifier has an associated attribute value identifier of ‘93745’, which indicates that the candidate 130 studied at Newcastle University. The candidate 130 has yet another associated candidate attribute that identifies that the ‘skill’ or ‘123’ attribute-type identifier has an associated attribute value identifier of ‘567’, which, as above, corresponds to Engineering.

Daily scripts may be run to check candidate 130 account information and the amount of activity on their accounts. Daily checks may be used to check a candidate's activity. If the candidate 130 is inactive for a certain period, this may be flagged on their account and reminders may be sent to the candidate 130, for example by e-mail.

If the candidate's account is active, a check may be carried out to determine whether all required candidate attributes or fields have been completed. If not, this may be flagged on their account and reminders may be sent to the candidate 130, for example by e-mail.

If all required fields on the account have been completed, it will then be checked whether the candidate 130 has fully completed their profile. If not, this may be flagged on their account and reminders may be sent to the candidate 130, for example by e-mail.

Daily checks may be run at a particular time, for example 1.00 am, every day to cache or identify all candidates 130 that meet certain minimum criteria. The cached or identified candidates 130 are then ready for matching with potential employers.

In some embodiments, the data matching platform 140 selects a predetermined candidate data set characterisation scheme from a plurality of predetermined candidate data set characterisation schemes. The selected predetermined candidate data set characterisation scheme corresponds to a set of desired candidate data set attributes indicative of the strength of a match against the one or more desired data set characteristics. In some embodiments, the data matching platform 140 selects a predetermined candidate data set characterisation scheme (also referred to herein as ‘candidate characterisation schemes’) from a plurality of predetermined candidate characterisation schemes. The selected predetermined candidate characterisation scheme corresponds to a set of desired candidate attributes indicative of the strength of a candidate 130 for the opportunity provided by the opportunity provider 120. As will be explained below, this provides a more holistic approach to candidate matching, which may yield more accurate candidate matches.

When caching or storing is complete, the data matching platform 140 may run searches or candidate characterisation schemes that pre-group candidates 130 and assign candidates 130 into one of a number of pre-defined ‘types’ or ‘personas’ based on candidate characterisation schemes or searches. The data matching platform 140 may apply objective weightings to the desired candidate attributes to reflect the importance of those attributes to the pre-defined types or personas. For example, a candidate characterisation scheme relating to an ‘engineering intern’ type or persona, is associated with certain characterisation rules and applies each of these rules to some or all candidates 130 to ascertain whether, and if so how strongly, any such candidates 130 conform to the ‘engineering intern’ type or persona.

The data matching platform 140 may select the predetermined candidate characterisation scheme at least in part on the basis of data indicating that the set of desired candidate attributes are indicative of a strong candidate 130 for the opportunity provided by the opportunity provider.

The data matching platform 140 identifies the desired candidate data set attributes corresponding to the selected predetermined candidate data set characterisation scheme. In some embodiments, the data matching platform 140 identifies the candidate attributes corresponding to the selected predetermined candidate characterisation scheme. This may be by querying the one or more databases 150 for the candidate attributes corresponding to the selected predetermined candidate characterisation scheme.

The data matching platform 140 retrieves, from the one or more databases 150, a set of weighting indicators indicating a relative weighting of each of the desired candidate attributes.

In some embodiments, data matching platform 140 retrieves a set of weighting indicators indicating a relative weighting of each of the identified candidate attributes from the one or more databases 150. This is so that the data matching platform 140 can determine how strongly particular candidate match the predetermined candidate characteristics, persona or type associated with the predetermined candidate characterisation scheme.

The data matching platform 140 may use external, open data or internal data to add weight to the candidate attributes. For example, an objective university ranking can be used to rate certain candidates 130 higher than others. In some cases, a candidate 130 may have studied a particular subject at a particular university (or other institution) in the past. In some embodiments, the ranking of the course and/or university may be determined as of the date of study, as opposed to its current ranking, so as to reflect the quality of the course and/or university when the candidate 130 studied there. This is to take account the fact that university and course rankings are dynamic and change over time.

As explained above, the relative weightings of at least some of the identified candidate attributes may be dynamic. For example, the weightings may change periodically or intermittently to better reflect the importance of certain candidate attributes in relation to certain candidate 130 characteristics schemes.

The data matching platform 140 may receive weighting data associated with desired candidate attributes and may derive, based at least in part on the received weighting data, the relative weighting of the desired candidate attributes. The weightings may change in response to receiving extrinsic information from which it can be determined that the relative weightings may need to be, or should be, changed. For example, as explained above, if the identified candidate attributes related to university courses, the rankings of which can change over time, extrinsic information identifying the latest rankings for certain courses may be received (possibly in response to requesting it) from which it can be determined that the relative weightings associated with certain university courses should be updated or revised in view of changes to the course rankings The received data may comprise information from one or more publicly available candidate attribute ranking databases. For example, in the case of university courses, the data may comprise course-ranking information that is widely available online.

At least some of the relative weightings may be based at least in part on one or more weighting adjustment parameters. For example, taking the case of university courses, the rank of a given course may change quite significantly over time. To account for the fact that different candidates 130 may have completed the course at different times, and that the rank of the course may have been different at those different times, the relative weightings may take into account not only the particular course studied, but also the rank of the course at the time is was studied. In such cases, the one or more weighting adjustment parameters may comprise a start and/or end date of study. Other weighting adjustment parameters are envisaged, for example the age at which a candidate 130 achieved a certain grade in an examination.

The data matching platform 140 may receive the set of weighting indicators and store the set of weighting indicators in the one or more databases 150.

Each candidate characterisation scheme has a set of rules attached to it. A rule queries candidate data to search for a relevant fact, keyword or candidate attribute and awards a certain number of points, for example depending on the location of the fact, keyword or candidate attribute in the candidate data. For example, identifying the keyword ‘engineering’ in association with a course of study may score more points than in association with a skill or interest. Each candidate characterisation scheme or search type may have many rules covering all the relevant attributes associated with a particular candidate type.

By way of example, with reference to the above, the ‘engineering type’ persona may be weighted mostly towards candidates 130 that have degree in engineering (rule 1), followed by candidates 130 who have a science degree (rule 2), followed by candidates 130 who have merely listed engineering as a soft skill or mere preference (rule 3). Attributes may be weighted in this way by allocating points, scores or other weighting indicators to the attributes.

Thus, rule 1 could be defined as: if the qualification_course attribute type identifier (‘3455’) has an attribute value=‘Engineering’ (or attribute value identifier ‘567’), then allocate twenty points to the candidate 130.

Rule 2 of could be defined as: if the qualification_course attribute type identifier (‘3455’) has an attribute value=‘Science’ (or attribute value identifier ‘3466’), then allocate ten points to the candidate 130.

Rule 3 for could be defined as: if the skill attribute type (having an attribute type identifier ‘567’) has an attribute value=‘Engineering’ (or attribute value identifier ‘567’), then allocate five points to the candidate 130.

It can be seen from this example that, based solely on performing a candidate characterisation for an ‘engineering intern’ persona, a candidate 130 that has a science degree would score more highly than a candidate 130 who merely mentions engineering as an interest or skill.

As shown in this example, weighting indicators may indicate a relative weighting of candidate attributes that comprise different attribute type identifiers but corresponding attribute value identifiers associated with the different attribute type identifiers. For example, one candidate attribute may comprise attribute type identifier A and associated attribute value B and another candidate attribute may comprise attribute type identifier C and attribute value B. In such cases, the weighting indicators indicate a relative weighting of the candidate attributes even though they both comprise the same attribute value, namely B.

As is also shown in this example, weighting indicators may indicate a relative weighting of any ones of said at least some of the candidate attributes that comprise corresponding attribute type identifiers but different attribute value identifiers associated with the corresponding attribute type identifiers. For example, one candidate attribute may comprise attribute type identifier A and associated attribute value B and another candidate attribute may comprise attribute type identifier A and attribute value C. In such cases, the weighting indicators indicate a relative weighting of the candidate attributes.

An employer can load up or run a pre-defined characterisation scheme to search for engineering interns, which would query the table in which the candidate data is stored for all candidates 130 who have a score above a particular threshold score (for example zero) for this search type.

Employers can then optionally apply further specific rules. For example, after conducting a search for engineering interns, an employer could further search or filter through the remaining candidates 130 for those who also have, for example, PHP as a skill. Alternatively, employers may decide not to specify a candidate characteristic search, but simply ask for all candidates 130 who have a PHP as a skill. In the latter case, matching candidates 130 would be identified and would be ranked by profile score, which may be somewhat more arbitrary.

More abstract candidate types or personas are envisaged. For example, an employer may wish to identify candidates 130 who show strong loyalty characteristics. A predefined candidate characterisation scheme for loyal candidates 130 may allocate a highest score to candidates 130 who have worked at a particular company for, say, five or more years, a lower score to candidates 130 who have worked at a particular company for, say, between one and five years, and a still lower score to candidates 130 who have worked at a particular company for, say, up to one year. Some of the scores may be negative in the sense that a candidate 130 that has accrued points may also be deducted points, for example if they have never worked for previous company for more than one year. ‘Loyalty’ may additionally or alternatively be determined based on how long a candidate 130 has worked on a particular sector and/or based on how many sectors the candidate has worked in. Other more abstract candidate types or personas such as ‘leadership’ etc are envisaged.

Candidate types or personas may be combined to form yet another layer of abstraction from the underlying candidate attributes. For example, the above two candidate characterisation schemes could be combined to search for ‘loyal engineering interns’. In other words, the granularity of the desired characteristic may be variable from a more fine-grained or specific characteristic to a more coarse-grained or abstracted characteristic. This provides a more holistic approach to candidate matching than simply checking whether a candidate has every single one of a list of desired attributes.

Thus, multiple candidate characterisation schemes may be used.

In some embodiments, the data matching platform 140 selects a further predetermined candidate data set characterisation scheme from the plurality of predetermined candidate data set characterisation schemes, the selected further predetermined candidate data set characterisation scheme corresponding to a set of further desired candidate data set attributes indicative of the strength of a match against the one or more further desired data set characteristics. In some embodiments, the data matching platform 140 identifies the further desired candidate data set attributes corresponding to the selected further predetermined candidate data set characterisation scheme. In some embodiments, the data matching platform 140 retrieves, from one or more databases, a set of weighting indicators indicating a relative weighting of each of the further desired candidate data set attributes. In some embodiments, the data matching platform 140 matches the further desired candidate data set attributes with candidate data set attributes in the first and second candidate data sets. In some embodiments, the data matching platform 140 ranks the first and second candidate data sets in relation to the selected further predetermined candidate data set characterisation scheme at least in part on the basis of said matching and said retrieved set of weighting indicators. In some embodiments, the data matching platform 140 generates one or more reports identifying the first and second candidate data sets and the relative rank of the first and second candidate data sets in relation to the selected further candidate data set characterisation scheme.

In some embodiments, the data matching platform 140 selects a further predetermined candidate characterisation scheme from the plurality of predetermined candidate characterisation schemes, the selected further predetermined candidate characterisation scheme corresponding to a set of desired candidate attributes indicative of the strength of a candidate 130 for the opportunity provided by the opportunity provider. The data matching platform 140 may identify candidate attributes corresponding to the selected further predetermined candidate characterisation scheme. The data matching platform 140 may retrieve, from one or more databases 150, a set of weighting indicators indicating a relative weighting of each of the identified candidate attributes corresponding to the selected further predetermined candidate characterisation scheme. The data matching platform 140 may match the identified candidate attributes corresponding to the selected further predetermined candidate characterisation scheme with candidate attributes in the first and second sets. The data matching platform 140 may determine a rank of the first and second candidates 130 in relation to the selected further predetermined candidate characterisation scheme at least in part on the basis of said matching and said retrieved set of weighting indicators. The data matching platform 140 may generate one or more candidate 130 matching reports identifying the first and second candidates 130 and the relative rank of the first and second candidates 130 in relation to the further selected candidate characterisation scheme.

The candidate characterisation scheme may be used to balance searches. For example, the word ‘accounting’ in the course name field for an accountants-type search may have more weight than the word ‘accounting’ in the course name for a web developer-type search.

The data matching platform 140 matches the desired candidate data set attributes with candidate data set attributes in the first and second candidate data sets.

In some embodiments, the data matching platform 140 matches the identified candidate attributes with candidate attributes in the first and second sets.

The data matching platform 140 ranks the first and second candidate data sets in relation to the selected predetermined candidate data set characterisation scheme at least in part on the basis of the matching and the retrieved set of weighting indicators.

In some embodiments, the data matching platform 140 ranks the first and second candidates 130 in relation to the selected predetermined candidate characterisation scheme at least in part on the basis of the matching and the retrieved set of weighting indicators.

The data matching platform 140 ranks and may benchmark candidates 130. The data matching platform 140 may allocate each candidate 130 a score based on their candidates attributes, which may relate to, but are not limited to:
University and Course Ranking
Academic Qualification (ranking according to level), for example a PhD may rank higher than a BA which may, in turn, rank higher than a Diploma)]
School Information (ranking and position relative to average grading)
Degree Classification (according to degree classification)
Course Information (ranking)
Professional work experience (length, duration and relevance)
Language Skills (number and fluency)
Scholarships, Merits, and Awards (number, award level, and timing)
Membership of Associations, Societies and Teams (length, duration, relevance, and seniority)
Completeness of Profile Information (percentage completion and frequency of updates)
Professional and Social Network Data (usage, connectivity, and engagement)
On-site response rate and engagement with employers and other users
Recommendations or rating on site
Profile Popularity (number of view/requests from employers)
Meta data collated on site relating to hiring interactions based on employer preferences
Independent and open Labour and Educational data and statistics
Number of on-site connections with employers and other users
Provision of reference information and any verified data
Results from online assessment test data
Video Interview Data and popularity (number and duration of views)
Last log-in date

In terms of ranking candidates 130 in general, the data matching platform 140 may also take into account the nature and level of a candidate's academic grade, the ranking of their educational institution, the type and length of any previous relevant work experience, the general activities of the candidate 130, the completeness of their profile, the presence of external authenticators such as references and any verified connections from social networks.

The data matching platform 140 generates one or more reports identifying the first and second candidate data sets and the relative rank of the first and second candidate data sets in relation to the selected candidate data set characterisation scheme.

In some embodiments, the data matching platform 140 generates one or more candidate matching reports identifying the first and second candidates 130 and the relative rank of the first and second candidates 130 in relation to the selected candidate characterisation scheme.

Candidate matching reports may be transmitted to the opportunity provider 120 via the data communication network 110.

An employer can filter the results of a candidate characterisation search, such as that described above, for example to look for candidates 130 who have as a skill, or otherwise mention, PHP. This does not affect the order or ranking as, for example, the most relevant marketing intern is still the most relevant regardless of whether or not they also mention PHP. The refinement or filtering discussed above merely removes candidates 130 from the candidate characterisation search who do not meet the (new) search criterion.

The data matching platform 140 may provide more robust searching and filtering than simple text-based or semantic searching. This is because information about the candidate 130 and/or employer is collected, grouped and weighed in a predetermined way. By way of example, all candidates 130 who have studied Law may be specifically and intentionally grouped together so that an employer who is interested in candidates 130 who have studied law need not rely on a text-based search which might bring up all candidates 130 with instances of the word “Law” in their CV, which may or may not relate to those candidates' study.

The data matching platform 140 may identify one or more additional candidate data set attributes associated with a given candidate data set, the strength of a match of the one or more additional candidate data set attributes against the one or more desired data set characteristics being known. The data matching platform 140 may then rank the first and second candidate data sets in relation to the selected predetermined candidate data set characterisation scheme at least in part on the basis of matching the first and second sets against the identified one or more additional candidate data set attributes.

The data matching platform 140 may identify one or more additional candidate attributes associated with a given candidate 130 for the opportunity provided by the opportunity provider, the strength of the given candidate 130 for the opportunity being known. The data matching platform 140 may rank the first and second candidates 130 in relation to the selected predetermined candidate characterisation scheme at least in part on the basis of matching the first and second sets of candidate attributes with the identified one or more additional desired candidate attributes.

The data matching platform 140 may identify one or more additional candidate attributes associated with a given candidate 130 for a previous opportunity provided by the opportunity provider, the strength of the given candidate 130 for the previous opportunity being known. The data matching platform 140 may rank the first and second candidates 130 in relation to the selected predetermined candidate characterisation scheme at least in part on the basis of matching the first and second sets of candidate attributes with the identified one or more additional desired candidate attributes.

In some embodiments, the data matching platform 140 may rank candidates 130 on the basis of interactions of such candidates with other similar opportunity providers.

The data matching platform 140 may thus provide predictive search matching wherein user information, external data and/or online interactions are monitored to suggest candidates 130 who might match an employer's preferences and/or who contain similar profiles to previous candidates 130 selected by the employer based on their profile information. The data matching platform 140 may use profiles, external and internal data to create an algorithm that should connect employers with the right candidates 130 with a good degree of certainty.

In some embodiments, the data matching platform 140 stores information relating to user (candidate 130 or recruiter) preferences, which may also be used to weight candidate 130 scoring. In such embodiments, the data matching platform 140 monitors user-selection processes and user-generated feedback and looks for similarities, for example the same or similar candidate attributes, between successful or popular candidates 130. This intelligence may then be used to find similar candidates 130 and increase their ranking. In some embodiments, the data matching platform 140 uses the results of psychometric and other testing mechanisms, which may be provided by the data matching platform 140 or otherwise, to assist with weighing the candidates 130.

Some embodiments provide a candidate 130 suggestion mechanism in which the data matching platform 140 is able to predict the type or persona of candidates 130 that are likely to be suitable for certain types of employers or employment opportunity. The data matching platform 140 may then suggest suitable opportunities to candidates 130 based on their likelihood of being be attractive to companies within a particular sector and/or may suggest suitable candidates 130 to such companies.

In terms of responsiveness and availability, the data matching platform 140 may monitor the responsiveness of candidates 130 and may identify those candidates 130 who are less responsive. Such candidates 130 may be demoted within rankings Such candidates 130 may even be removed if they do not respond to invites from employers, for example by marking them as unavailable.

Online assessments and verification methods may be performed. In some such embodiments, candidates 130 can undergo assessments including tests, (live or recorded) video or audio interviewing within the system. The assessments can be used as part of an automated or semi-automated screening process or system and/or to rank the candidates 130. Some embodiments relate to carrying out automated or semi-automated processes that can verify skills, criteria, or qualifications of candidates 130 using email, electronic and other communication methods. Some embodiments allow integrated online assessments including tests, video or audio interviewing within the system. In some embodiments, results of assessments are gathered, collated, scored, ranked, and verified via automated and/or semi-automated processes.

The data matching platform 140 may provide or comprise a feedback mechanism that allows users (job-seekers or employers) to provide feedback, comments and ratings. The data matching platform 140 may provide or comprise a profile monitoring mechanism. Some such embodiments collate and monitor user data for popularity.

The data matching platform 140 may provide or comprise a training mechanism that generates and collates content (using automated and non-automated means) for training purposes in the form of tutorials, presentations, knowhow, knowledge and material which can be accessed, used, and modified by users. The data matching platform 140 may contain, collate and/or create a database of content (using automated and non-automated means) for the purposes of intern training or learning facility.

Some embodiments relate to search and matching candidates 130 with employers. Employers can thereby search for candidates 130 who match their needs instantly in three ways:
via instant search inputting search criteria including degree level, stage of learning, institution, availability, skills, work experience, test scores, location, and other profile data;
via job posting which sends an application request to candidates 130 who hold the criteria of the position; and
via searching and contacting candidates 130 who are “following” your company.

The data matching platform 140 may allow employers to search for candidates 130 who meet certain criteria for an opportunity and then contact the matching clients directly. Employers may then advertise opportunities that can be communicated to candidates 130 who match the criteria associated with the opportunity.

The data matching platform 140 may comprise or provide a training and improvement mechanism to benchmark candidate data against other candidates 130 to suggest improvement(s) to candidate 130 profiles so that they might improve their ranking to collate between employer preferences. The data matching platform 140 may indicate and compare data between candidates 130 as against their peers within their academic institution, subject group, degree level, preferred sector and location. The data matching platform 140 may generate and collate content (using automated and semi-automated means) to provide training in the form of tutorials, presentations, tests, and material which can improve can be accessed and modified by users. The data matching platform 140 may contain a question and answer module which allows users to generate and score content relating to various topics that can improve skill sets or improve profile data.

Some embodiments provide company news following wherein candidates 130 can follow and be feed news items and job information relating to companies that they are interested in joining.

The data matching platform 140 may provide virtual and online assignments or digital work. Employers may post and assign virtual assignments to selected candidates 130, for example in the following manner:
the employer posts the assignment, deadline, and pays a fee for its completion;
candidates 130 apply for the assignment and can be contacted about the assignment;
the employer selects the “winning” candidate 130 who must complete the assignment by the deadline; and
the employer is given the assignment via a secure channel and payment is made to the candidate 130 upon acceptance.

At least some embodiments described above relate to a data matching platform 140 for matching a plurality of candidate data sets against one or more desired data set characteristics in a data communication system 100. The data matching platform 140 is arranged to receive a first candidate data set comprising a first set of candidate data set attributes and receive a second candidate data set comprising a second set of candidate data set attributes. The data matching platform 140 is arranged to select a predetermined candidate data set characterisation scheme from a plurality of predetermined candidate data set characterisation schemes, the selected predetermined candidate data set characterisation scheme corresponding to a set of desired candidate data set attributes indicative of the strength of a match against the one or more desired data set characteristics. The data matching platform 140 is arranged to identify the desired candidate data set attributes corresponding to the selected predetermined candidate data set characterisation scheme. The data matching platform 140 is arranged to retrieve, from the one or more databases 150, a set of weighting indicators indicating a relative weighting of each of the desired candidate data set attributes. The data matching platform 140 is arranged to match the desired candidate data set attributes with candidate data set attributes in the first and second candidate data sets. The data matching platform 140 is arranged to rank the first and second candidate data sets in relation to the selected predetermined candidate data set characterisation scheme at least in part on the basis of said matching and said retrieved set of weighting indicators. The data matching platform 140 is arranged to generate one or more reports identifying the first and second candidate data sets and the relative rank of the first and second candidate data sets in relation to the selected candidate data set characterisation scheme.

The data matching platform 140 may comprise, or there may otherwise be provided, a computer program product comprising a non-transitory computer-readable storage medium having computer readable instructions stored thereon, the computer readable instructions being executable by a computerized device to cause the computerized device to perform the computer-implemented method described herein.

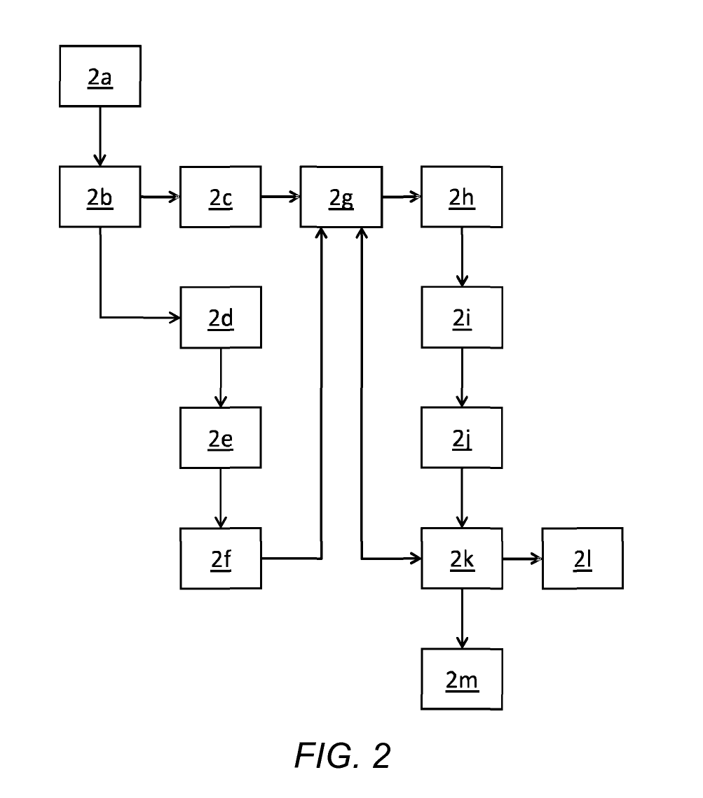

FIG. 2 is a flow chart showing a computer-implemented method of matching candidates with opportunities according to some embodiments. The method may provide instant searches as described above. In these embodiments, the candidates 130 are interns.

At step 2a, the data matching platform 140 retrieves candidate 130 information from the one or more databases 150.

At step 2b, the data matching platform 140 runs regular scripts to profile and cache all interns who meet the minimum standard. The script may run, for example, at 1:00 am daily.

At step 2c, for each intern, the data matching platform 140 caches each candidate attribute also referred to herein as a ‘fact’ for each intern. This may comprise storing one candidate attribute per row in a table.

At step 2d, the data matching platform 140 retrieves predefined search types.

At step 2e, the data matching platform 140 retrieves predefined keywords, fields and match scores for each match type.

At step 2f, the data matching platform 140 searches each intern's account for each defined keyword in each defined field. If it matches, the data matching platform 140 adds a new row and score for each search type.

At step 2g, the data matching platform 140 stores or caches this information in the one or more databases 150.

At step 2h, the data matching platform 140 retrieves the latest interns from the cache table (default search). The retrieved interns are ranked by their general profile score which may be somewhat arbitrary.

At step 2i, the data matching platform 140 optionally selects a predefined intern type, for example a marketing intern.

At step 2j, the data matching platform 140 optionally selects additional filters, such as languages, skills, education levels or the like.

At step 2k, the data matching platform 140 retrieves the selected search criteria and runs the search again.

At step 2l, the data matching platform 140 logs each search request and type for analysis and for re-use.

At step 2m, the data matching platform 140 displays the results with pagination and previous. The data matching platform 140 allows the employer to pin, compare, ask questions and connect to interns.

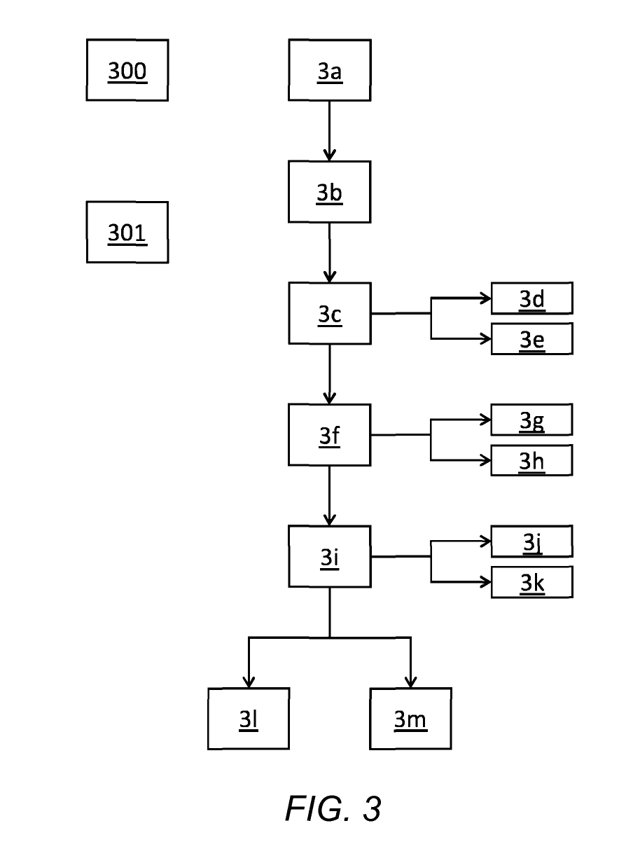

FIG. 3 is a flow chart showing a computer-implemented method according to some embodiments. The method may provide instant search as described above. In these embodiments, the candidates 130 are interns.

FIG. 3 depicts a first intern 300. The first intern 300 studied Law, at Oxford University and achieved a first class degree. The first intern 300 lists their skills as law, communication, contract law and employment law.

FIG. 3 also depicts a second intern 301. The second intern 301 studied Marketing and Economics, at Liverpool University and achieved a first class degree. The second intern 301 lists their skills as marketing, communication, economics and market analysis.

At step 3a, the data matching platform 140 processes the data associated with the interns 300, 301 based on a candidate 130 character type of ‘marketing intern’.

At step 3b, the data matching platform 140 obtains a list of rules associated with the ‘marketing intern’ type and applies them to the first and second interns.

At step 3c, the data matching platform 140 applies rule 1, wherein twenty points are awarded to the intern if the intern's qualification course contains ‘marketing’.

At steps 3d and 3e, the data matching platform 140 awards zero (no match) and twenty points (match) to the first and second interns respectively.

At step 3f, the data matching platform 140 applies rule 2, wherein ten points are awarded to the intern if the intern's skills contains ‘marketing’.

At steps 3g and 3h, the data matching platform 140 awards zero (no match) and ten points (match) to the first and second interns respectively.

At step 3i, the data matching platform 140 applies rule 3, wherein ten points are awarded to the intern if the intern's skills contains ‘communication’.

At steps 3j and 3k, the data matching platform 140 awards one (match) and one point (match) to the first and second interns respectively.

At step 3l, the data matching platform 140 determines the total scores for both interns.

At steps 3m and 3n, the data matching platform 140 determines that the total score for the second intern is thirty-one points and the total score for the second intern is one point, from which it can be determined that the second intern represents a better ‘marketing intern’ than the first intern.

As can be seen from this example, as profiling or characterisation proceeds, a process akin to natural selection ensues; a candidate 130 who is suitable for, say, marketing generally naturally mentions associated keywords more often than candidates 130 that are not suitable. The more suitable candidates 130 will therefore be awarded more points as the scheme runs each of the associated rules, thus giving the stronger, more suitable candidates 130 them more weight and placing them further up the rankings. Those candidates 130 who are less suitable mention such keywords less often and will therefore be placed lower in the rankings, if at all. Of course, on another search type the latter candidates 130 may be ranked differently.

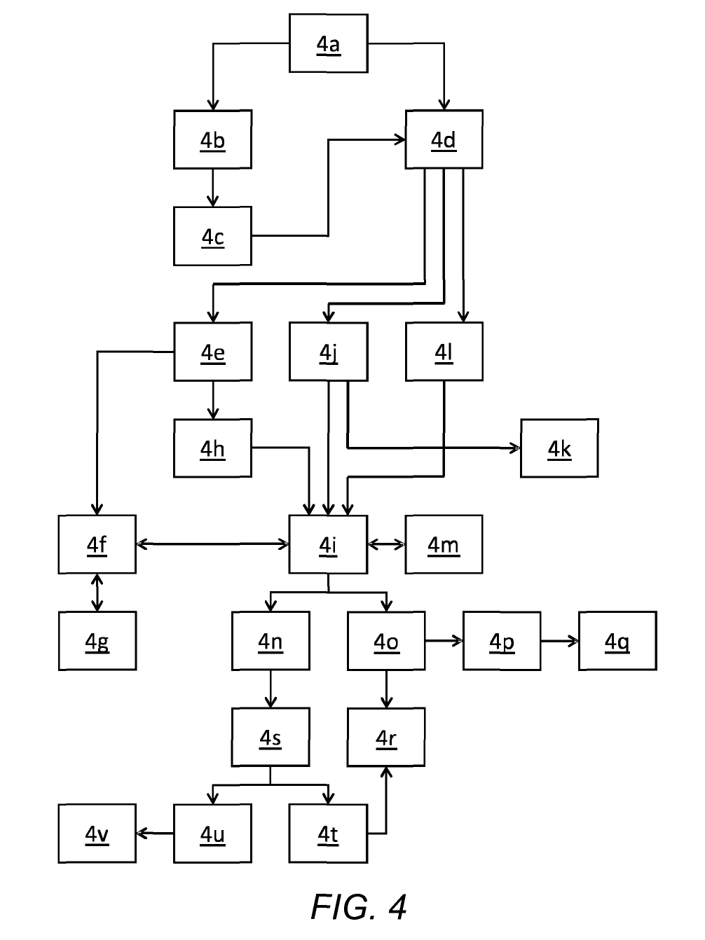

FIG. 4 is a flow chart showing a computer-implemented method according to some embodiments.

At step 4a, the data matching platform 140 determines that an employer wishes to use the candidate 130 matching service.

At step 4b, the data matching platform 140 determines whether or not the employer is already a member.

At step 4c, if not, the data matching platform 140 enables the employer to sign up, provide a setup wizard and then activates the employer's account.

At step 4d, the data matching platform 140 determines that the employer is an activated member.

At step 4e, the data matching platform 140 enables the employer to post an internship. The data matching platform 140 allows the employer to enter internship details and submit for activation.

At steps 4f and 4g, the data matching platform 140 checks whether the employer has sufficient credits and, if not, enables the employer to purchase additional credits.

At step 4h, if the employer has sufficient credits, the data matching platform 140 returns a shortlist of interns.

At step 4i, the data matching platform 140 allows the employer to contact proactively interns one by one and deducts credits accordingly. Processing may return to steps 4f and 4g if necessary.

At step 4j, the data matching platform 140 enables the employer to perform an instant search. The user can use filters and sorting to display a list of interns.

At step 4k, for example in the future, the data matching platform 140 allows the employer to add notes, stars, pins or the like to an intern.

Processing returns again to step 4i and steps 4f and 4g if necessary.

At step 4l, the data matching platform 140 allows the employer browse categories. The employer may be able to select certain categories to be able to view lists of interns.

At step 4m, if an intern identified at step 4i is a very desirable intern, the data matching platform 140 informs the employer accordingly.

At steps 4n and 4o respectively, the data matching platform 140 determined whether the employer has a standard or a subscribed account.

If the employer has a employer has a subscribed account, at steps 4p and 4q, the data matching platform 140 adds the interns identified at step 4i to a basket for bulk ordering (for subscribed and corporate members only) and may produce bulk mailouts or orders.

At step 4r, if the employer has a subscribed account, the employer is allowed access to the intern's or interns' details and CVs, for example for 30 days.

If at steps 4n and 4o, the data matching platform 140 determined that the employer has a standard account, at step 4s, the data matching platform 140 sends a message (for example an email) to a selected intern to inform the intern that the employer wishes to consider them for an opportunity. The message asks whether employer may contact the intern.

If, at step 4t, the intern responds positively, for example within 48 hours, processing returns to step 4r, where the employer is allowed access to the intern's or interns' details and CVs, for example for 30 days.

If, at step 4u, the intern does not respond positively (for example if the intern does not respond or declines), at step 4v, the data matching platform 140 issues a refund to the employer.

Thus, in terms of application management, in a first-round screening, completed applications may be automatically profiled and scored according to a predefined list of rules, which allows the operator to check and make private notes on completed applications. The operator may also contact each candidate 130 via the data matching platform 140 or by video interviewing (one-way or two-way) or provide invites for in person interviews, recording the outcome of the interview and scoring the candidate 130. Once a telephone interview and score have been saved alongside an application, the application is marked as ‘screened’.

In a second-round screening, completed and screened applications may be automatically profiled and scored as before, but taking into consideration the operator's results. From this list of applications, a finalists list may be selected by the operator. All other applications may be marked as unsuccessful.

In terms of finalist management, the operator may be able to contact finalists by bulk e-mail, upload information for each candidate 130 (for example contract information, a schedule, travel information etc) and add notes of any communication that is made with them. The operator may also have the ability to post messages for other successful applicants to read and reply to ‘publicly’ (possibly only visible to logged in finalists).

In terms of program management and private networking interaction, finalists may be able to log in and view any information the operator has supplied for them on a finalist by finalist basis, as well as ‘public’ messages for all finalists. Finalists may be able to ask questions, interacting with the operator and other finalists. Semi-anonymity may be delivered for example by only providing a profile image of each finalist and their first name. In some embodiments, no other details would be available.

In terms of connections, in order to view and connect with a specific candidate 130, credit may be required. If no credit is available, the employer may purchase new credits. However, if credit is available, a connection request routine may be commended upon confirming that credit should be deducted and a receipt may be issued, for example via post or email.

The employer may then contact, for example by e-mail, the candidate 130 and a permission request may be communicated to the candidate 130 accordingly. The candidate 130 may have a certain time period, for example 24 hours, in which to respond to the request. If the candidate 130 responds positively, some or all of the candidate's profile is made available to the employer and communication between both parties is enabled. Both parties may be notified, for example by e-mail, and linked to a conversation page. On the conversation page, both parties may be able to send and receive messages and arrange interviews. Once messages are posted, the recipient may be notified, for example by e-mail, that they have at least one new message pending. There may be no limit on the total numbers of messages can be sent.

If the candidate 130 responds negatively, in the sense that they are not interested in the opportunity or otherwise decline, the employer may request issuance of a refund of the payment that was deducted for effecting the connection. The employer may then be notified of the credit, for example by post or e-mail. The employer may then begin another search for a suitable candidate 130.

In some embodiments, the employer may create a new opportunity by specifying basic or more complete information about the opportunity. The employer may then specify one or more desired candidate 130 characteristics. An approximate or actual number of matches may be indicated. The employer may then be able to specify specific candidate attributes for the opportunity, for example skills, languages, experience and educational levels. Weightings may be applied to some or all of these attributes, for example to indicate that some attributes are highly desirable, essential, optional, preferred or the like. An updated number of matches may then be indicated. The employer may then select, check and confirm any matches in which they are interested and, again, an updated numbers of matches may be indicated.

In some embodiments, one or more regular script runs daily. The script checks for new opportunities and may marking them as ‘active’. The one or more scripts may search for any matching candidates 130 across all active internships and may invite any such matching candidates 130 them to opt-in in relation to the relevant opportunities. The one or more scripts may then check for closing internships and may mark them as ‘closing’. Non-respondents may then be offered a final chance to opt-in. The one or more scripts may then also check for closed internships and may mark them as ‘closed’. The employer may then be sent, for example by e-mail, a summary of matching candidates 130 and/or inviting them to view and search through the matching candidates 130. The results may be shown within the context of the instant search as a pre-defined search (for example a candidate characterisation search), with opt-ins shown. The results may then be communicated, for example by e-mail, to the employer.

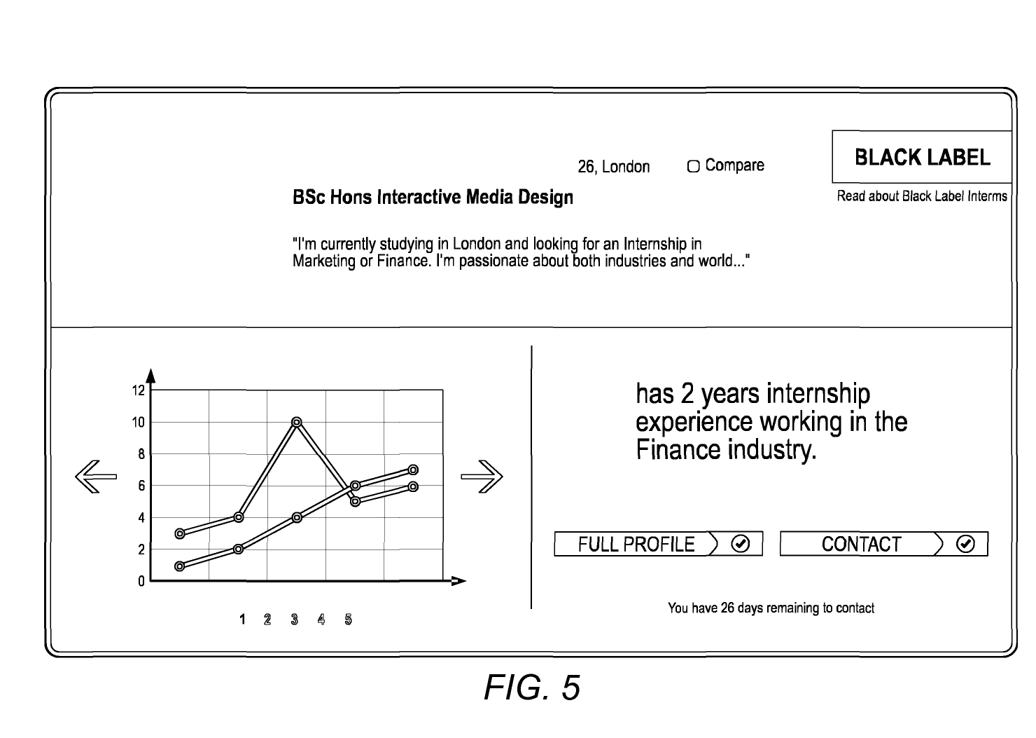

FIG. 5 is a representation of a side by side candidate 130 profile comparison in accordance with some embodiments.

Some embodiments provide side by side profile comparison and comparative analysis. The standardised layout and format of the candidate 130 profiles means that the candidate 130 information provides a robust platform for search and comparison between candidates 130. The data matching platform 140 may compare variables across average candidate data with a selected group or sector and allow the employer to see how an individual candidate 130 performs against the others in the group.

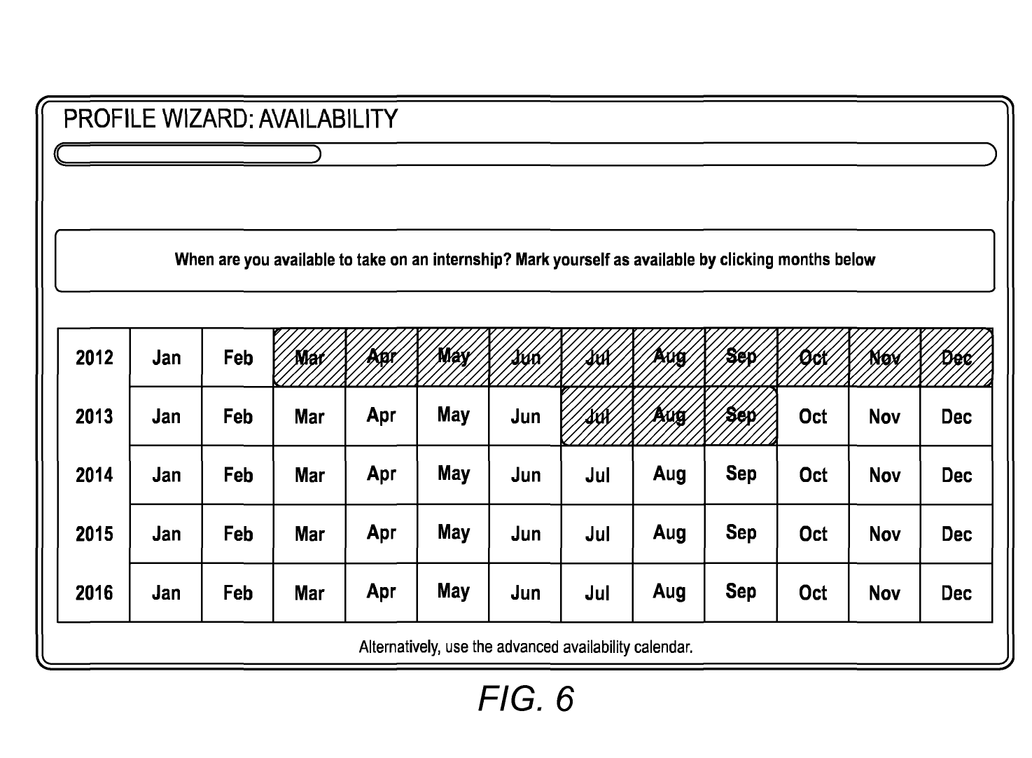

FIG. 6 is a representation of a dynamic availability dashboard in accordance with some embodiments. The availability of a candidate 130, for interviews for employment or the like, may be amended using the dynamic availability dashboard.

The data matching platform 140 may thus provide or comprise an availability matching mechanism via the dynamic availability dashboard to allow user data (relating to job-seekers and employers) to be matched to ensure suitable availability for job opportunities.

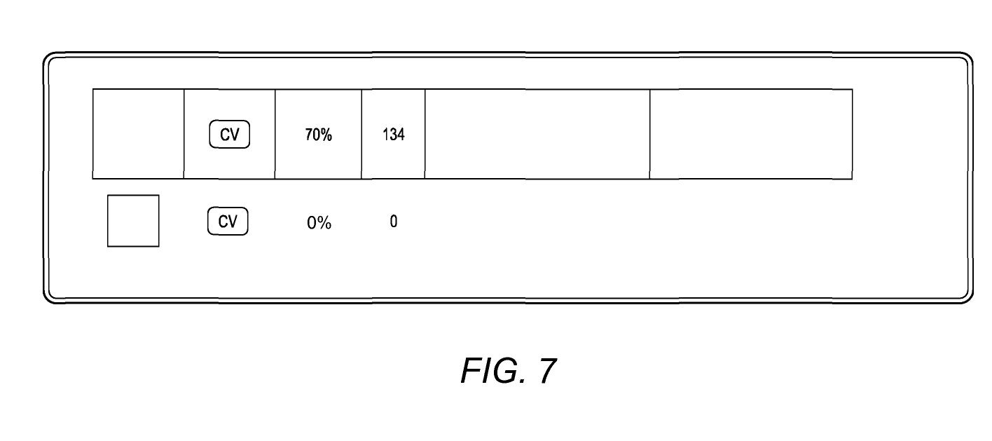

FIG. 7 is a representation of a candidate ranking record in accordance with some embodiments.

The data matching platform 140 may allocate each candidate 130 an internal, private score, which may be stored in the one or more databases 150, for each attribute that can be used to rank, match, or benchmark candidates 130 against one another on an objective basis.

As depicted in FIG. 7 by the score ‘134’ and ‘0’, the data matching platform 140 may store a ranking or the score associated with each of the first and second candidates 130 in relation to the selected predetermined candidate characterisation scheme in the one or more databases 150. The data matching platform 140 may retrieve the ranking associated with candidates 130 in relation to a selected predetermined candidate characterisation scheme from the one or more databases 150.

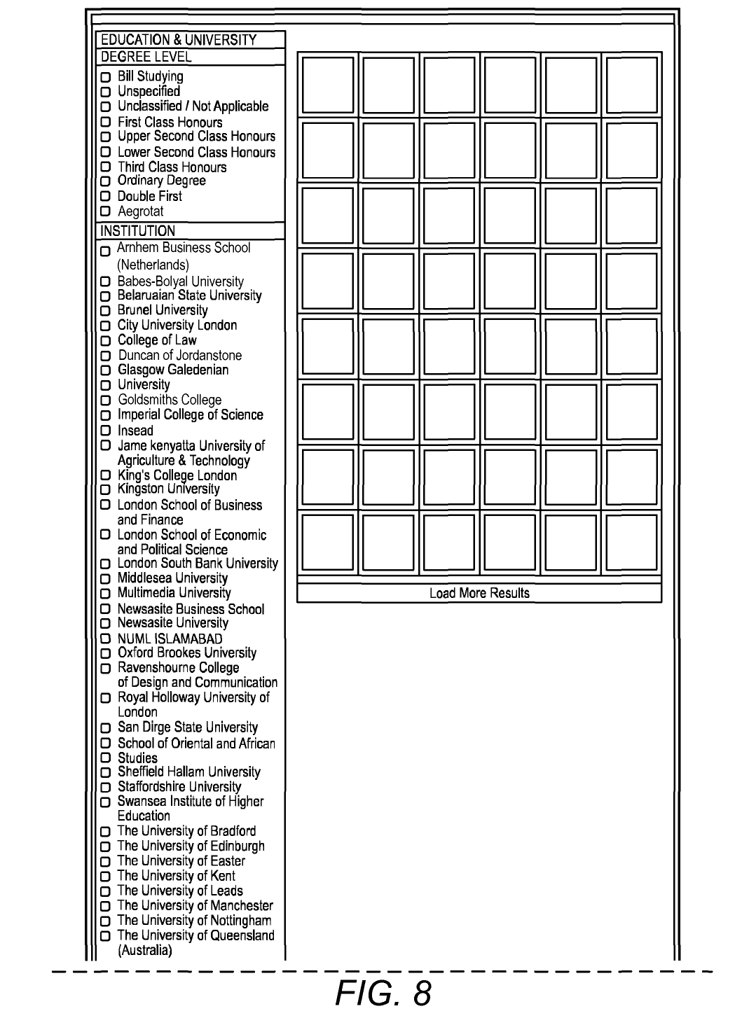

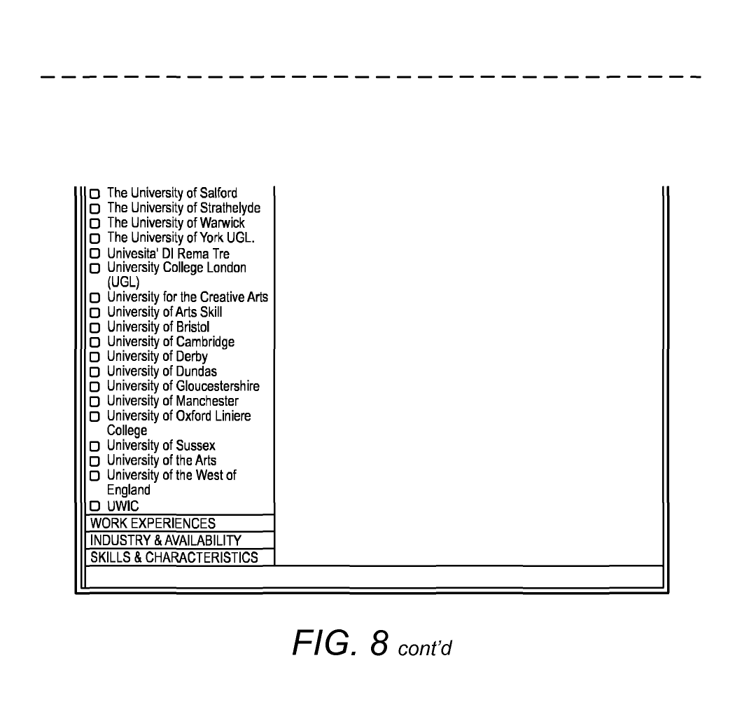

FIG. 8 is a representation of a generated report in accordance with some embodiments.

The report identifies a plurality of candidates and relative rankings by ordering pictures associated with the candidates in descending rank order.

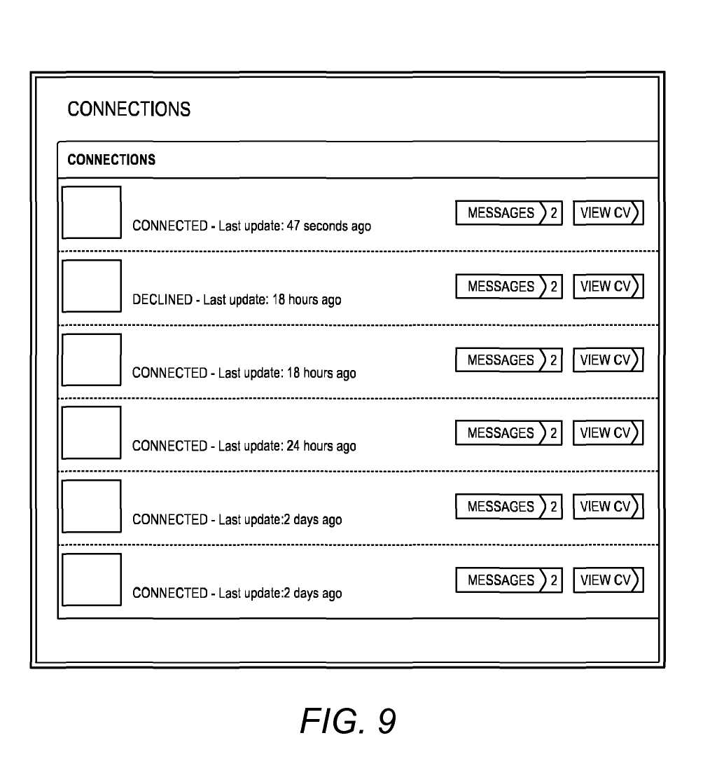

FIG. 9 is a representation of a list of connections in accordance with some embodiments.

In some embodiments, the data matching platform 140 provides an integrated or internal mechanism for messaging and contacting candidates 130 which stores, tracks, and monitors candidate 130 information and profile updates. This data can be share across the employer team.

Candidates 130 and/or employers may receive and respond to connections and messages from employers and/or other candidates 130 directly from the dashboard, by completing a connections and messages routine. Some embodiments relate to assessment, messaging, and contacting candidates 130.

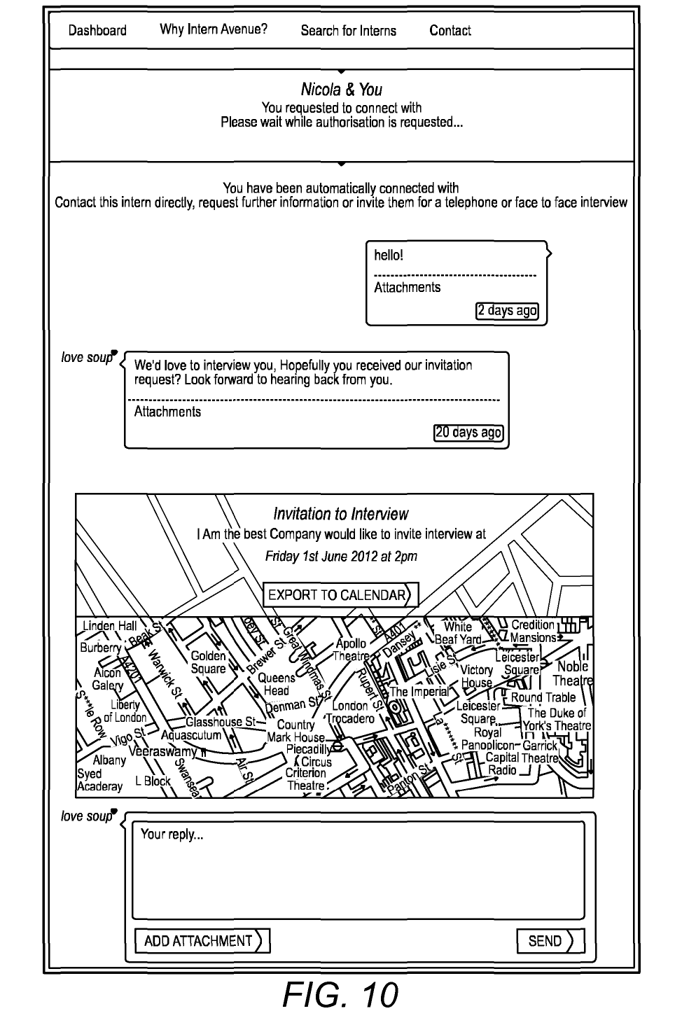

FIG. 10 is a representation of an interview arrangement page in accordance with some embodiments.

In some embodiments, the data matching platform 140 allows employers to contact and request additional information from candidates 130 and/or invite candidates 130 to take an online assessment, submit reference information, invite candidates 130 to take a one-way or two-way video or telephone interview, arrange the interview times and location details and to offer positions.

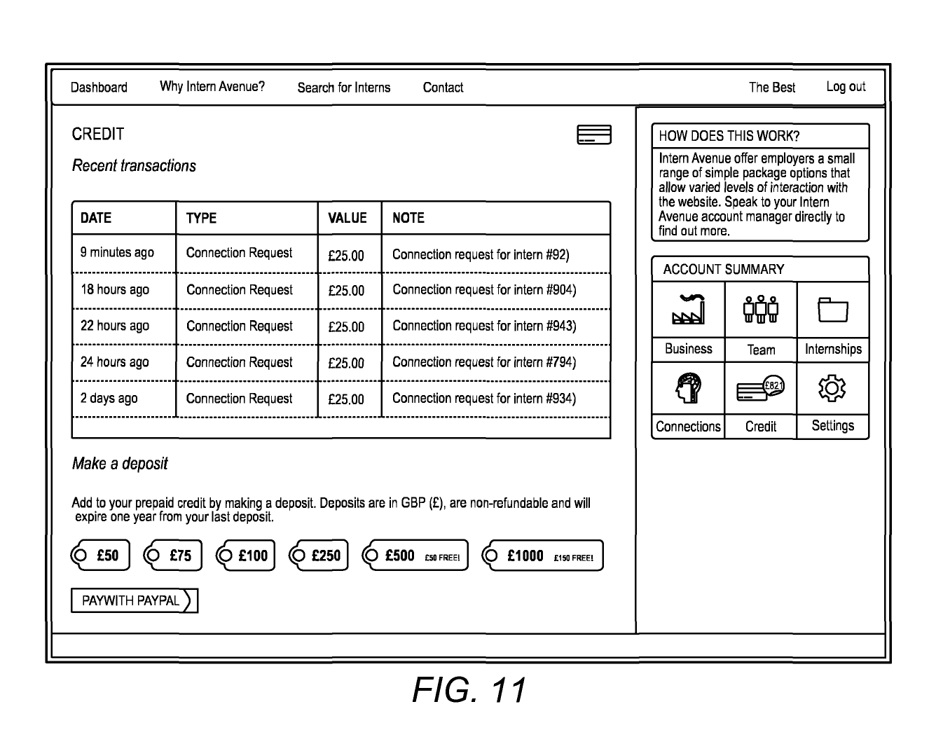

FIG. 11 is a representation of payment and transaction page in accordance with some embodiments.

Some embodiments provide payment integration via the payment and transaction page. The data matching platform 140 may contain payment integration which allows employers to purchase direct contact with candidate 130 users instantly.

If the employer does not have an account with credits, from the dashboard, they may then be able to view the available packages and purchase a package that is suitable for their usage. To purchase a package, payment can be made online, in which case a receipt may be sent to the employer (for example by post or e-mail), or offline, in which case the employer sends payment details and notifies of the payment. The payment may be manually processed and a receipt may then be sent to the employer, for example by post or e-mail.

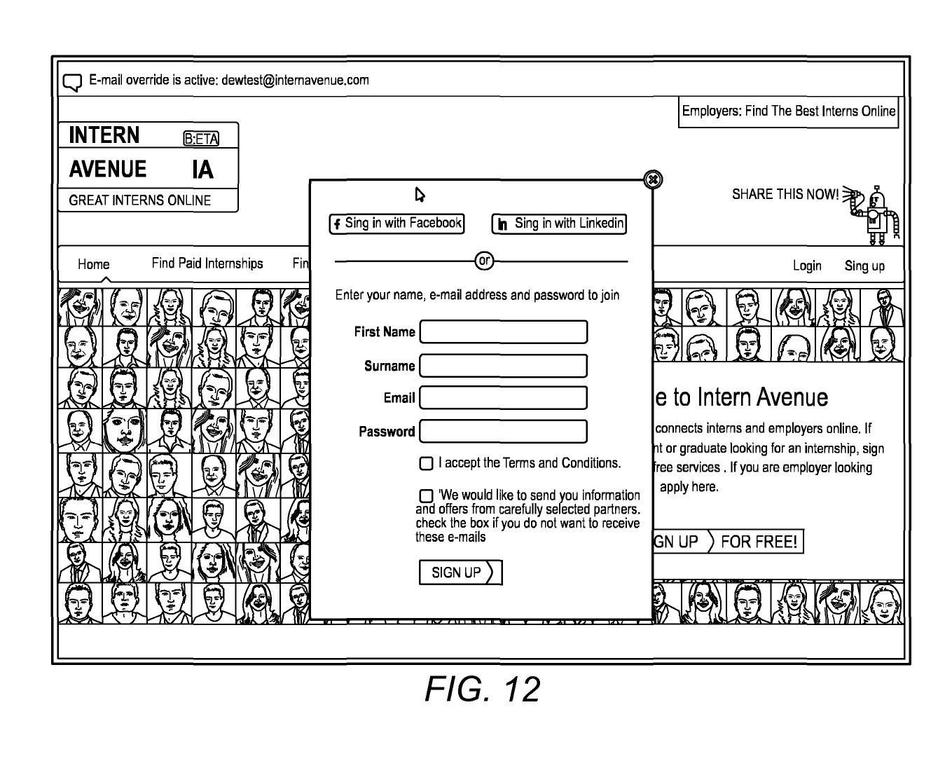

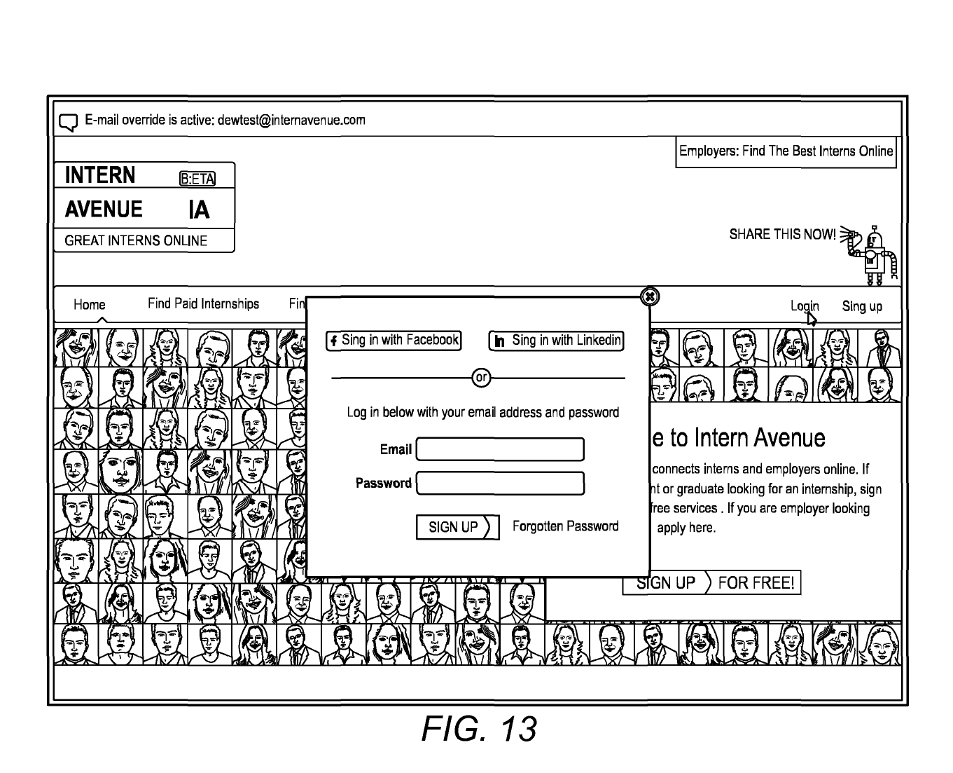

FIGS. 12 and 13 are each representations of a login page in accordance with some embodiments.

In terms of candidate data capture and collection, a user browses a website associated with the candidate matching service and may be given the option to sign up as a candidate 130 or as an opportunity provider 120 such as an employer. As a candidate 130, the user can sign up using login information from Facebook, LinkedIn or another open source or social network. Alternatively, they can manually input login information using, for example, an email address and password.

In some embodiments, a candidate 130 can manually input login information using, for example, an email address and password.

In terms of accessing the data matching platform 140 and authentication when accessing the data matching platform 140, in some embodiments, visitors may browse a website acting as a portal to the data matching platform 140, but may require that the candidate 130 then register through an authentication process.

There are a number of options to authenticate the candidate 130.

One option is for the candidate 130 to attempt to authenticate themselves using authentication details associated with another website or service, for example using Facebook™ account details, where oAuth is used. If this is successful, and it is their first sign up, the candidate 130 goes on to create their account. If they have already created an account, once authenticated they may be directed to visit a dashboard and/or CV profile page. If authentication fails, the candidate 130 is invited to attempt authentication again, via a different authentication mechanism.

Another option is for the candidate 130 to attempt to authenticate themselves using authentication details associated with another website or service, for example using LinkedIn™ account details, where oAuth is used. If this is successful, and it is their first sign up, the candidate 130 goes on to create their account. If they have already created an account, they may then be directed to their dashboard and/or CV profile. If authentication fails, the candidate 130 is invited to attempt authentication again, via a different authentication mechanism.

Another option is for the candidate 130 to authenticate themselves natively. In this case, the client provides any necessary authentication details. If this is successful, and it is their first sign up, the candidate 130 then goes on to create their account. If they have already created an account, once authenticated, they may be directed to their dashboard and/or CV profile. If authentication fails, the candidate 130 is invited to attempt authentication again, via a different authentication mechanism.

Other authentication processes may be available including, but not limited to, Twitter™ and other social networks.

Once one of these options has been chosen and actioned successfully, sign up and authentication is complete.

The procedure for employers to sign up to the candidate matching service is somewhat similar to that for candidates 130.

In terms of browsing and authentication, employers may start by browsing the website associated with the candidate 130 matching service, then may move to an authentication process.

There are a number of authentication options.

One option is for the employer to authenticate themselves via LinkedIn account details, where oAuth is used. If this is successful, and it is their first sign up, the employer goes on to create their account.

Another option is for the employer to authenticate themselves natively. In this case, the employer provides any authentication information. If this is successful, and it is their first sign up, the employer then goes on to create their account.

In either case, once created, the employer account may be inactive by default, to be manually approved by an administration team. Once approval has been granted, the employer is notified, for example by email, and the employer account is activated and is fully accessible. If the employer has already created an account, once authenticated they may be directed to their dashboard. If authentication fails, the employer is invited to attempt authentication again, via a different authentication mechanism.

Once one of these authentication options has been chosen and actioned successfully, employer sign up and authentication is complete.

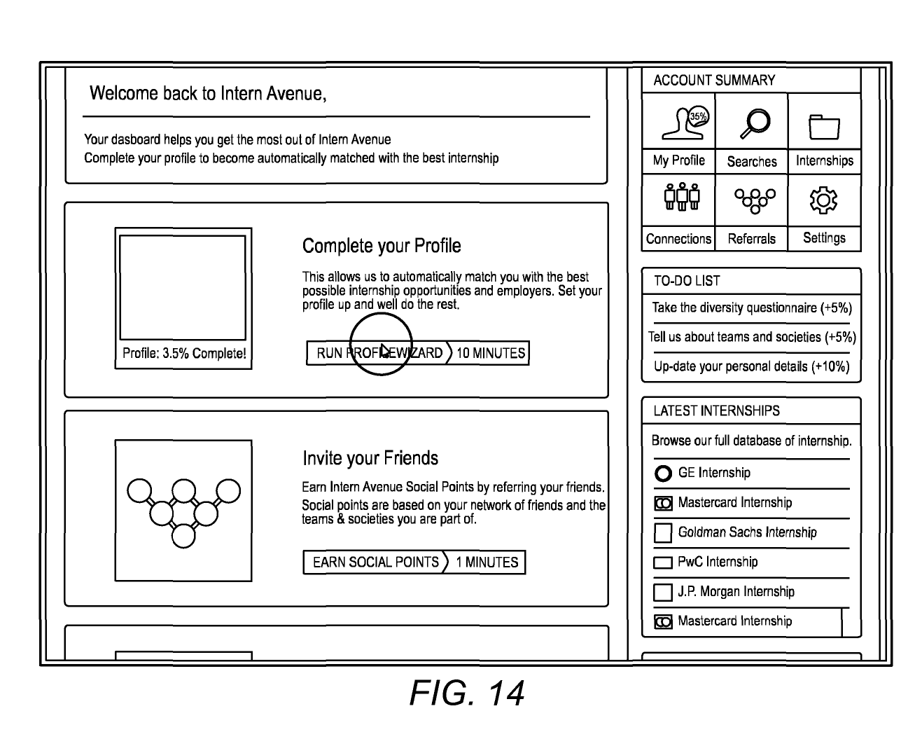

FIG. 14 is a representation of a dashboard page in accordance with some embodiments.

In terms of navigation from the candidate's dashboard, candidates 130 may update account details and preferences in terms of job roles. Any such updates are then saved.

Candidates 130 may also be able to browse employment opportunities proactively and opt-in for, or otherwise indicate an interest in, advertised positions from the dashboard, using a browse and opt-in routine.

The dashboard also allows candidates 130 to launch and run a profile completion wizard.

In terms of navigating from the dashboard, the employer may be able to make account and preference updates. Any such updates are then saved in the one or more databases 150.

The dashboard may also allow employers to launch and run a profile wizard. This wizard allows employers to import data from Linkedln or other social networks, their own website or some other source, or natively. The employers may need to authenticate again to be able to import the data. Any imported data is reviewed and, if all is accepted, the imported data is saved against the employer in the one or more databases 150.

If the employer account is active, the employer then determines whether the account has a package with credits, or whether their account includes any free credits.

If so and the account does have credits, employers are able to search for candidates 130 using the instant search routine, post a recruitment opportunity using a routing to post an employment opportunity, and respond to connections and messages and/or perform other actions.

If the employer does not have an account with credits, from the dashboard, they may then be able to view the available packages and purchase a package that is suitable for their usage.

The instant search routine allows employers with active accounts to search for candidates 130 that match their requirements. There are a variety of search options available.

One option is that employers can select pre-defined candidate 130 search results, such as candidate characterisation searched, of cached results of active and fully completed candidate 130 profiles. The employer may then be able to view a list of candidate 130 matches and options. Once the search list is complete, employers may then deactivate the search mechanisms. Any matches may then be displayed along with the candidates' status(es), for example opted in, opted out, waiting.

The employer may then a use preview, pin and compare routine to ask selected candidates 130 a public question through the website. The question is logged on the site. Any such selected candidates 130 are then notified of the question, for example via email or secure communications within the website. Candidates 130 then visit their account profile and reply to the question. Their reply is communicated, for example e-mailed, to the specific employer and posted publicly.

Another option is that employers may search specifically amongst candidates 130. The employer may be prompted first to select an intern type or persona corresponding to a candidate 130 characteristic search from a pre-defined list. The results of this search are filtered and ordered or ranked by best and, for example, most recent candidates 130. The employer may then be given the opportunity to apply additional filters to the remaining candidates 130. If this step is carried out, again the search results are filtered and ordered by best and, for example, most recent candidates 130.

Another option is that employers may be able to find matches based on cached or saved results. These results may then either be stored or the employer may ask, for example by email, matching candidates 130 to opt in if they are interested in the employer and/or a particular opportunity. If the candidate 130 responds positively, the employer may then add the candidate 130 to a shortlist within the search results, which then updates a candidate 130 matches and opt-in list. If the candidate 130 does not respond or says they are not interested in the opportunity, the employer may remove the candidate 130 from the shortlist and hide the candidate 130 or mark the candidate 130 as unavailable in the search results. The candidate 130 matches and opt-ins list is then updated.

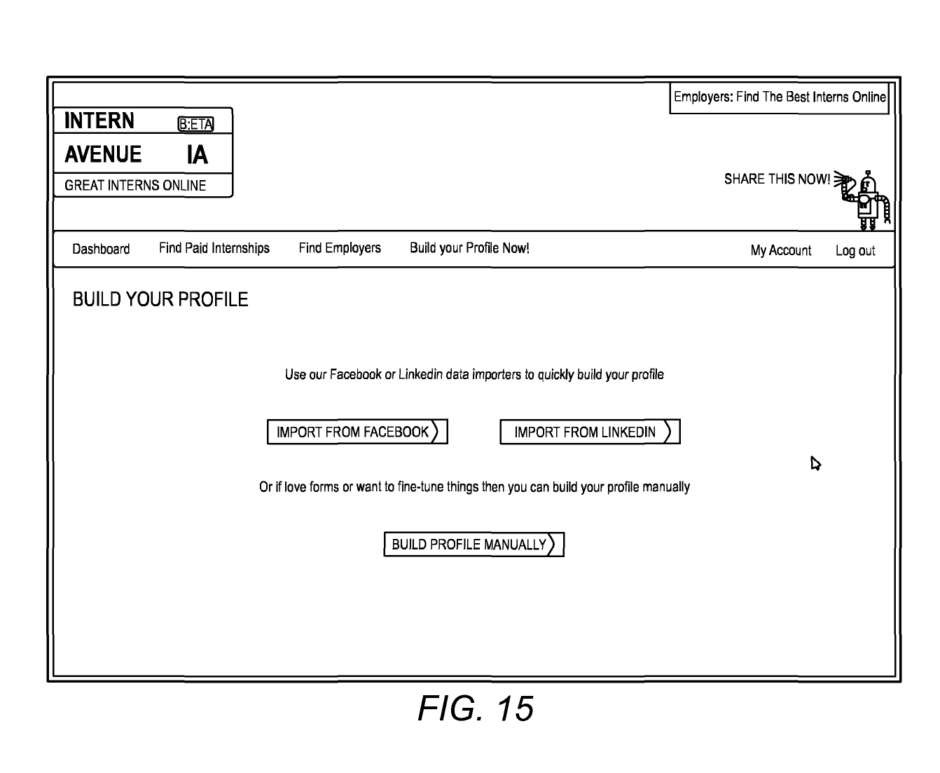

FIG. 15 is a representation of a profile building prompt page in accordance with some embodiments.

Following login, the candidate 130 may be prompted to run a profile setup wizard. The profile setup wizard may provide the user with certain options to populate their profile with relevant professional data, preferences, availability and other candidate attributes. The candidate 130 may be able to import such information from other social network profiles, such as Facebook and LinkedIn.

Alternatively, the candidate 130 may be able to build their profile manually. If they choose to do so manually, they are taken step by step through a series of stages to populate their profile. This may include entering their personal information, profile pictures, contact information, job preferences including location, industry sector and salary expectations.

The profile building prompt page allows candidates 130 to import candidate data from Facebook, LinkedIn or the like, or to enter it natively. The candidate 130 may need to authenticate themselves at this stage to be able to import the candidate data. The imported data may then be reviewed and, if all imported data is accepted, the candidate data is saved in the one or more databases 150 against the candidate 130.

The profile building prompt page prompts the candidate 130 to build their profile.

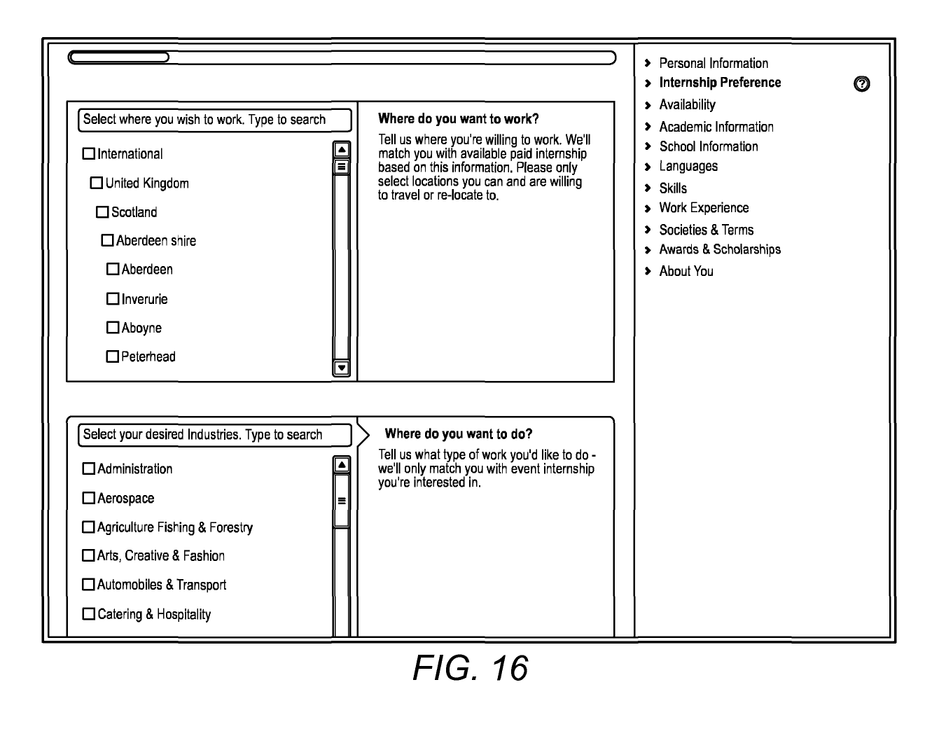

FIG. 16 is a representation of an internship preference page in accordance with some embodiments.

The candidate 130 may be able to specify preferences relating to the internsip via the internship preference page.

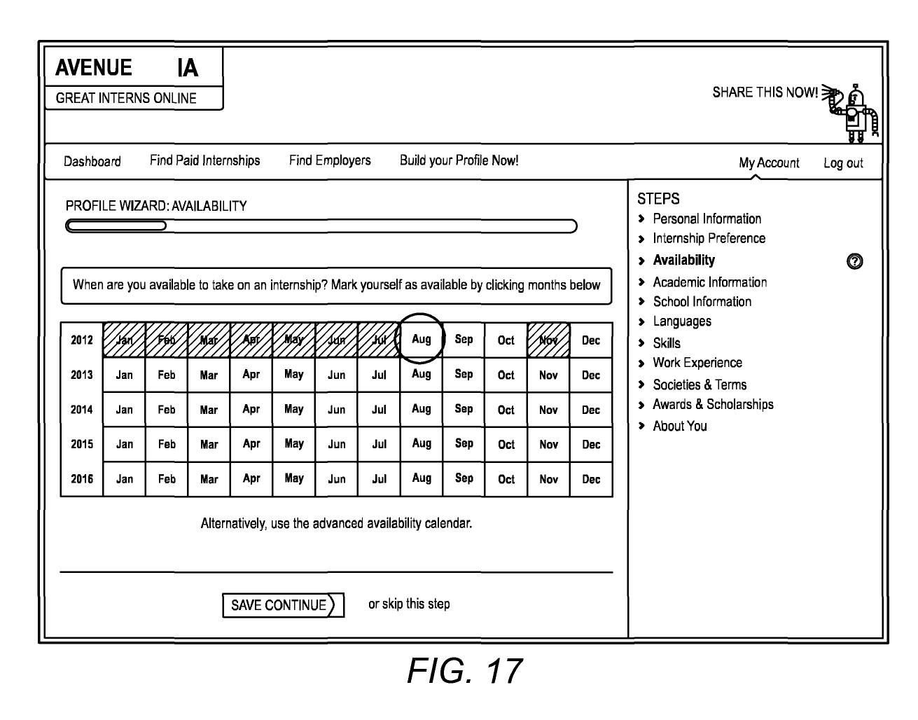

FIG. 17 is a representation of an availability profile wizard page in accordance with some embodiments.

The availability of a candidate 130, for interviews for employment or the like, may be amended using the availability profile wizard page.

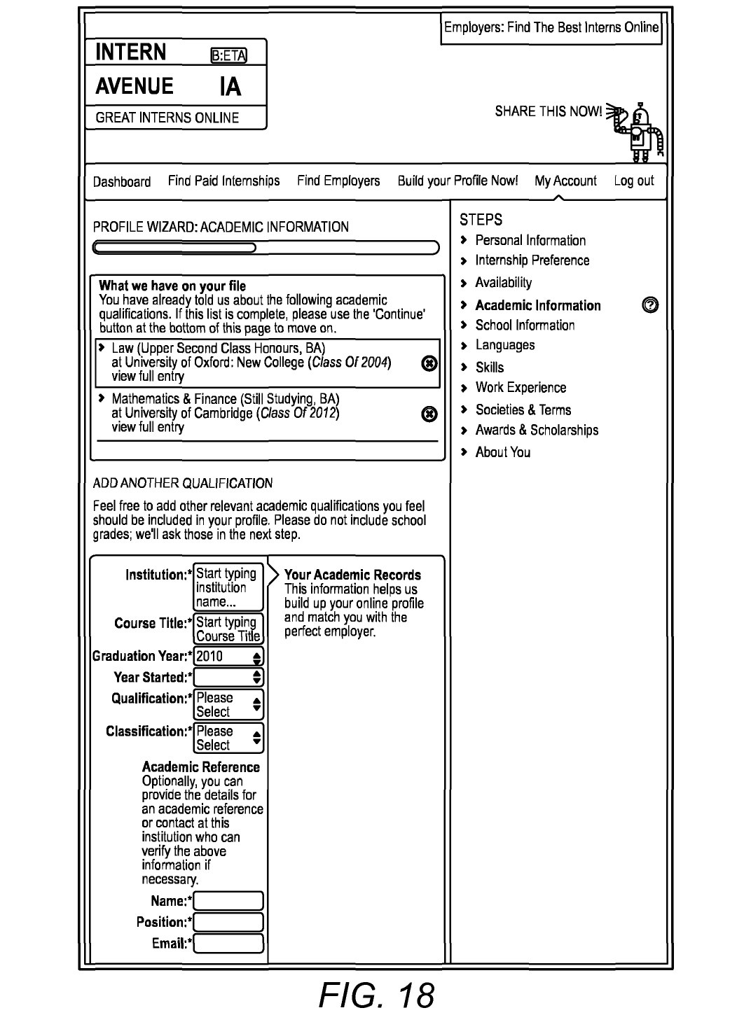

FIG. 18 is a representation of an academic information profile wizard page in accordance with some embodiments.

The candidate 130 may be able to provide some or all of the following information, and/or or other relevant information, as part of their academic information, via the academic information profile wizard page:
Institution
1 Course title
Graduation year and start year
Level of qualification and type
Classification given
Academic references

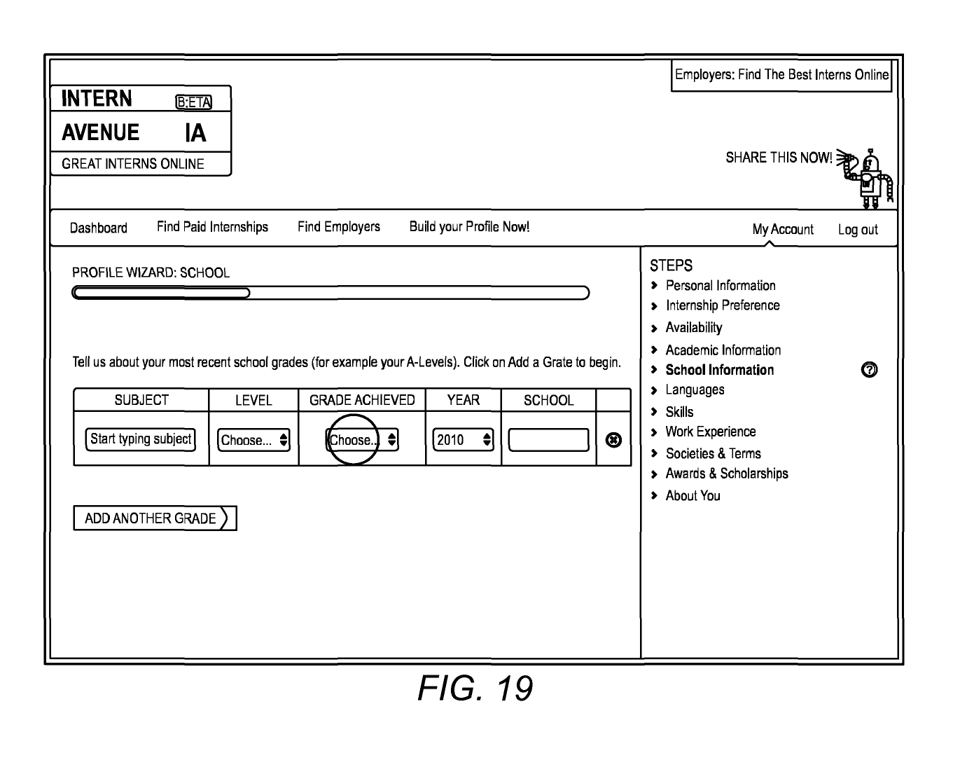

FIG. 19 is a representation of a school profile wizard page in accordance with some embodiments.

The candidate 130 may be able to provide some or all of the following information, and/or or other relevant information, as part of their school information, via the school profile wizard page:
Grades and subjects for A levels, GCSEs and equivalent qualifications
Location of school
Type of school

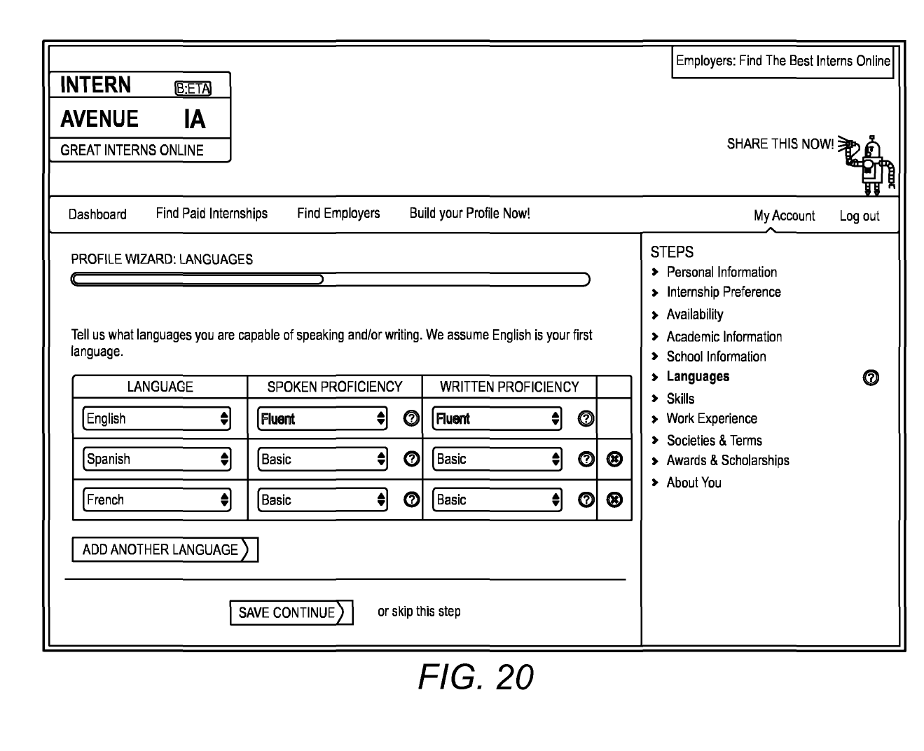

FIG. 20 is a representation of a languages profile wizard page in accordance with some embodiments.

The candidate 130 may be able to provide some or all of the following information, and/or or other relevant information, as part of their language proficiency information languages profile wizard page:
Language
Written proficiency
Spoken proficiency

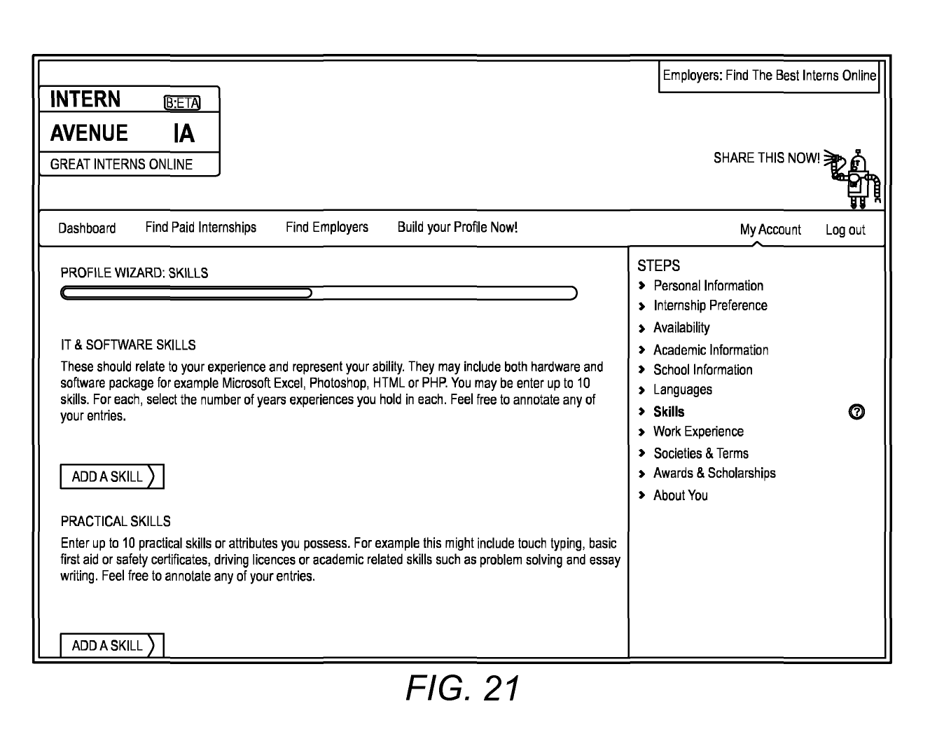

FIG. 21 is a representation of a skills profile wizard page in accordance with some embodiments.

The candidate 130 may be able to identify any relevant IT/software skills or any practical skills they have, via the skills profile wizard page.

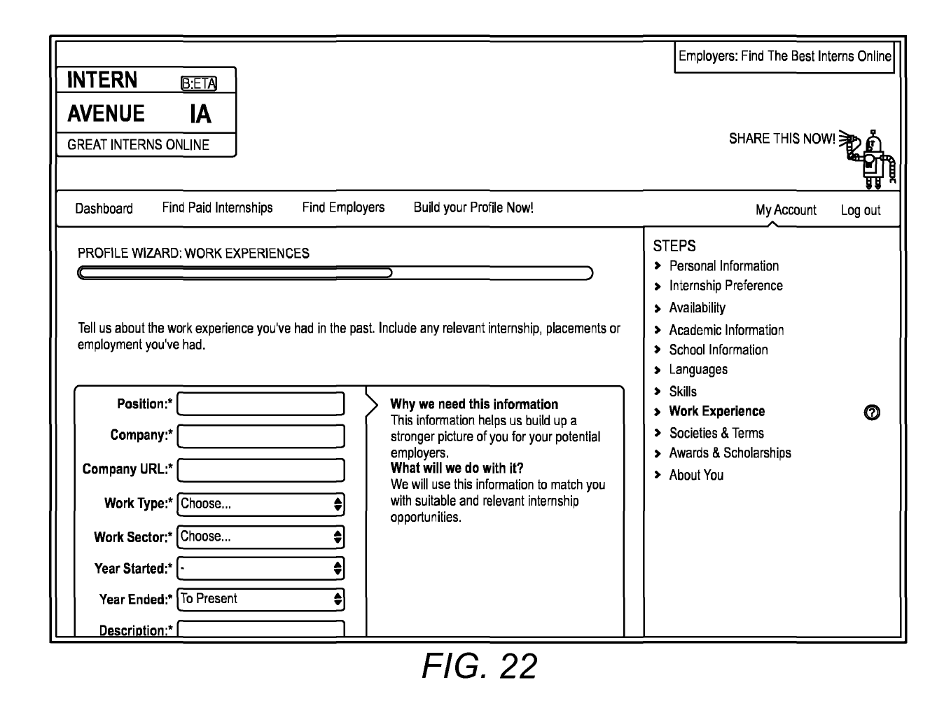

FIG. 22 is a representation of a work experience profile wizard page in accordance with some embodiments.

The candidate 130 may be able to provide relevant information about the sector and any work experience that they may have work experience, via the work experience profile wizard page.

The data matching platform 140 may provide hosted microsites for application processes. The microsites may contain many features and modules available within the platform but may be customised for the specific needs of the employer (the ‘operator’). The microsite allows candidates 130 to apply for an employer-managed job application or hiring program online. The microsite ensures that candidates 130 meet certain criteria before progressing with an application, and may include online assessment such as multiple choice, case studies, psychometrics and other testing. The microsite also provides the operator with an administration facility to manage applications and interact with candidates 130, as well as sorting and selecting successful applicants. Upon selection, the micro-site allows successful candidates 130 to access information about their internship, contract information, employment details and travel arrangements, as well as ask questions and communicate with other successful candidates 130 through a private communication facility. This facility may be protected by a login system. The microsite may generate weekly status updates to the operator, reporting on traffic, the number of applicants, and other such statistics.

In terms of the microsite and online application, the site may provide a customised interface and brand which will be hosted on the relevant domain name to specification. The site may display information on the job application or programme, contact information etc. which is provided by the operators. An interactive application form may be designed and built which is broken down into steps and that automatically saves as the candidate 130 progresses. The first stage may require the candidate 130 to enter an e-mail address and a password, so they can return to the application or check on its status at any time. Once their application meets the operator specified criteria and they have undertaken any testing, the candidate 130 can submit the application for consideration. It is likely that there will be a closing date for applications, in which case the micro-site's application facility would be closed to new applicants.

In terms of web accessibility, the application process may be fully accessible to all major internet browsers, particularly disability assistive browsers and may comply with various accessibility standards. There may be the option for the operator to create applications on behalf of candidates 130 who may apply by post or over the telephone, who do not have access to or cannot apply online for any reason. This ensures that applicants with special requirements are not disadvantaged or adversely impacted as part of the selection process.

As described above, candidates 130 may be matched, searched, assessed, filtered, trained or screened based on the required skills, preferences, and/or other specified criteria associated with a job. Such processing may take place via an automated or partially automated online interface. Data, for example candidate data, may be sorted and manipulated for purposes including (but not limited to) the recruitment of job seekers, searching for job vacancies and/or use relating to internships. Job-seeking candidates 130 may be matched, filtered and screened with or for suitable job opportunities with employers. The required skills, preferences, and/or other specified criteria may be matched via an automated or partially automated online system.

The data matching platform 140 may provide online application and matching methods to allow users, for example candidates 130 to apply, forward, and/or input information and/or data relating to job opportunities and can undertake filtering, matching and screening of information according to preferences and/or other specified criteria. Candidates 130 may apply or forward information or data for job opportunities including pre-filtered and matched vacancies that suit their skills, preferences and/or other specified criteria. The data matching platform 140 may filter, select, and forward suitable data or information according to required skills, preferences and/or other specified criteria specified by employers.

The data matching platform 140 may provide filtering and selection methods. The data matching platform 140 may provide an automated or semi-automated process and/or system of positioning, selecting, screening, or matching job seekers and employers based on data provided including profile information, skills, preferences and/or other specified criteria including online assessments. The data matching platform 140 may provide online search and information-collation methods, for example to allow users (job-seekers or employers) to conduct targeted searches for opportunities based on their requirements, skills, preferences, and/or other specified criteria. Employer may be able to conduct targeted searches for job seekers and/or data and/or information based on their requirements, skills, preferences, and/or other specified criteria. The data matching platform 140 may provide an information or data gathering system and/or process via automated and partially automated means that collects relevant data relating including URL links, data and information, which can then be accessed and search, matched or filtered from a centralised database. The data matching platform 140 may be able to filter candidates 130 according to search criteria and then rank the best candidates 130 according a matching and ranking algorithm.

The data matching platform 140 may be used to create a detailed and standardised profile, allocate a ranking and, if necessary, can assess and/or verify key details with online assessments, reference requests, hyperlinks to relevant information, preferences, work samples, and video interview information.

The data matching platform 140 may provide a web-based service that allows two user groups to find and connect to one another via a smart matching process and filtering mechanism. The data matching platform 140 may thereby serve as a centralised meeting place for employers and candidates 130.

The above embodiments are to be understood as illustrative examples of the invention. Further embodiments of the invention are envisaged.

For example, the candidate characterisation searches described above have been referred to as predetermined. Ad hoc candidate characterisation searches are envisaged. For example, the weightings associated with the candidate characterisation searches may be calibrated in real time and corresponding changes to rankings may be reported.

In some embodiments, the data matching platform 140 may collect preferences and other metrics about the user that are not generally provided on a CV such as salary expectation, availability, sectors, locations and companies or other opportunities they are looking for.

Although embodiments have been described above that relate to computer-implemented methods of matching candidates with opportunities offered by opportunity providers, such computer-implemented methods may also be used in various contexts to provide more holistic data matching against one or more desired data set characteristics.

Embodiments are envisaged that involve matching several groups or entities, such as volunteers with charities, possible business partners with business opportunities and the like.

For example, embodiments are envisaged in which the candidate data set attributes in the candidates data sets each represent one or more attributes of one or more physical entities, such as one or more human beings. In some embodiments, the one or more attributes relate to physical attributes (such as height, weight or age) of the one or more physical entities. In some embodiments, the one or more attributes relate to psychological attributes (such as IQ) of the one or more physical entities.

Embodiments are envisaged in which the candidate data sets represent biometric information (for, for example, a fingerprint) relating to one or more physical entities, such as one or more human beings. In such embodiments, it may be desirable to match the candidate data sets against stored biometric information to determine a match.

Embodiments are envisaged in which the candidate data sets represent one or more other data items, such as one or more digital items, for example digital media items such as digital image items, digital video items, digital audio item, one or more digital files or the like. In such embodiments, it may be desirable to match the candidate data sets against stored information to determine a match.

Although embodiments have been described above wherein employers may use the data matching platform 140 to search for job applicants for a given employment (in which case the applicants may be considered to be candidates for the job), other embodiments are envisaged in which a job seeker may use the data matching platform 140 to search for potential employers (in which case, the employers may be considered to be candidate (or possible) employers for the job seeker). As explained above, the terms ‘candidate’ and ‘opportunity provider’ should be considered accordingly.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer-implemented method of matching a plurality of candidate data sets against one or more desired data set characteristics in a data communication system, the method comprising:
receiving a first candidate data set comprising a first set of candidate data set attributes;
receiving a second candidate data set comprising a second set of candidate data set attributes;
selecting a predetermined candidate data set characterisation scheme from a plurality of predetermined candidate data set characterisation schemes, the selected predetermined candidate data set characterisation scheme corresponding to a set of desired candidate data set attributes indicative of the strength of a match against the one or more desired data set characteristics;
identifying the desired candidate data set attributes corresponding to the selected predetermined candidate data set characterisation scheme;
retrieving, from one or more databases, a set of weighting indicators indicating a relative weighting of each of the desired candidate data set attributes;
matching the desired candidate data set attributes with candidate data set attributes in the first and second candidate data sets;
ranking the first and second candidate data sets in relation to the selected predetermined candidate data set characterisation scheme at least in part on the basis of said matching and said retrieved set of weighting indicators; and
generating one or more reports identifying the first and second candidate data sets and the relative rank of the first and second candidate data sets in relation to the selected candidate data set characterisation scheme.

2. A method according to claim 1, wherein at least some of the candidate data set attributes comprise an attribute type identifier and an attribute value identifier associated with the attribute type identifier.

3. A method according to claim 2, wherein the weighting indicators indicate a relative weighting of any ones of said at least some of the candidate data set attributes that comprise different attribute type identifiers but corresponding attribute value identifiers associated with the different attribute type identifiers.

4. A method according to claim 2, wherein the weighting indicators indicate a relative weighting of any ones of said at least some of the candidate data set attributes that comprise corresponding attribute type identifiers but different attribute value identifiers associated with the corresponding attribute type identifiers.

5. A method according to claim 1, wherein the relative weightings of at least some of the desired candidate data set attributes are dynamic.

6. A method according to claim 1, comprising:
receiving weighting data associated with at least some of the desired candidate data set attributes; and
deriving, based at least in part on the received weighting data, the relative weighting of the at least some of the desired candidate data set attributes.

7. A method according to claim 6, wherein the received weighting data comprises information from one or more publicly available attribute ranking databases.

8. A method according to claim 1, wherein at least some of the relative weightings are based at least in part on one or more weighting adjustment parameters.

9. A method according to claim 1, comprising:
selecting a further predetermined candidate data set characterisation scheme from the plurality of predetermined candidate data set characterisation schemes, the selected further predetermined candidate data set characterisation scheme corresponding to a set of further desired candidate data set attributes indicative of the strength of a match against the one or more further desired data set characteristics;
identifying the further desired candidate data set attributes corresponding to the selected further predetermined candidate data set characterisation scheme;
retrieving, from one or more databases, a set of weighting indicators indicating a relative weighting of each of the further desired candidate data set attributes;
matching the further desired candidate data set attributes with candidate data set attributes in the first and second candidate data sets;
ranking the first and second candidate data sets in relation to the selected further predetermined candidate data set characterisation scheme at least in part on the basis of said matching and said retrieved set of weighting indicators; and
generating one or more reports identifying the first and second candidate data sets and the relative rank of the first and second candidate data sets in relation to the selected further candidate data set characterisation scheme.

10. A method according to claim 1, comprising:
identifying one or more additional candidate data set attributes associated with a given candidate data set, the strength of a match of the one or more additional candidate data set attributes against the one or more desired data set characteristics being known; and
ranking the first and second candidate data sets in relation to the selected predetermined candidate data set characterisation scheme at least in part on the basis of matching the first and second sets against the identified one or more additional candidate data set attributes.

11. A method according to claim 1, comprising:
receiving the first and second candidate data sets via one or more data communication networks.

12. A method according to claim 1, comprising:
transmitting data associated with the one or more generated reports via one or more data communication networks.

13. A data matching platform for matching a plurality of candidate data sets against one or more desired data set characteristics in a data communication system, the data matching platform being arranged to:
receive a first candidate data set comprising a first set of candidate data set attributes;
receive a second candidate data set comprising a second set of candidate data set attributes;
select a predetermined candidate data set characterisation scheme from a plurality of predetermined candidate data set characterisation schemes, the selected predetermined candidate data set characterisation scheme corresponding to a set of desired candidate data set attributes indicative of the strength of a match against the one or more desired data set characteristics;
identify the desired candidate data set attributes corresponding to the selected predetermined candidate data set characterisation scheme;
retrieve, from one or more databases, a set of weighting indicators indicating a relative weighting of each of the desired candidate data set attributes;
match the desired candidate data set attributes with candidate data set attributes in the first and second candidate data sets;
rank the first and second candidate data sets in relation to the selected predetermined candidate data set characterisation scheme at least in part on the basis of said matching and said retrieved set of weighting indicators; and
generate one or more reports identifying the first and second candidate data sets and the relative rank of the first and second candidate data sets in relation to the selected candidate data set characterisation scheme.

14. A computer program product comprising a non-transitory computer-readable storage medium having computer readable instructions stored thereon, the computer readable instructions being executable by a computerized device to cause the computerized device to perform a computer-implemented method of matching a plurality of candidate data sets against one or more desired data set characteristics in a data communication system, the method comprising:
receiving a first candidate data set comprising a first set of candidate data set attributes;
receiving a second candidate data set comprising a second set of candidate data set attributes;
selecting a predetermined candidate data set characterisation scheme from a plurality of predetermined candidate data set characterisation schemes, the selected predetermined candidate data set characterisation scheme corresponding to a set of desired candidate data set attributes indicative of the strength of a match against the one or more desired data set characteristics;
identifying the desired candidate data set attributes corresponding to the selected predetermined candidate data set characterisation scheme;
retrieving, from one or more databases, a set of weighting indicators indicating a relative weighting of each of the desired candidate data set attributes;
matching the desired candidate data set attributes with candidate data set attributes in the first and second candidate data sets;
ranking the first and second candidate data sets in relation to the selected predetermined candidate data set characterisation scheme at least in part on the basis of said matching and said retrieved set of weighting indicators; and
generating one or more reports identifying the first and second candidate data sets and the relative rank of the first and second candidate data sets in relation to the selected candidate data set characterisation scheme.
